(19) United States
(12) Patent Application Publication
(10) Pub. No.: US 2026/0052419 A1
(43) Pub. Date: Feb. 19, 2026

(54) SUPPORT OF DATA TRANSMISSION MEASUREMENT ACTION GUARANTEE FOR DATA DELIVERY SERVICE

(71) Applicant: InterDigital Patent Holdings, Inc., Wilmington, DE (US)

(72) Inventors: Quang LY, North Wales, PA (US); Dale SEED, Allentown, PA (US); Catalina MLADIN, Hatboro, PA (US); Lu LIU, Conshohocken, PA (US)

(73) Assignee: InterDigital Patent Holdings, Inc., Wilmington, DE (US)

(21) Appl. No.: 19/103,057

(22) PCT Filed: Aug. 10, 2023
(86) PCT No.: PCT/US2023/072009

§ 371 Date: Feb. 11, 2025

Related U.S. Application Data
(60) Provisional application No. 63/371,270, filed on Aug. 12, 2022.

(51) Int. Cl. H04W 24/10; H04L 43/0829; H04L 43/087; H04L 43/0894; H04W 24/08

(52) U.S. Cl. CPC H04W 24/10; H04L 43/0829; H04L 43/087; H04L 43/0894; H04W 24/08

(57) ABSTRACT

Methods are described herein for SEALDD data transmission measurement and data delivery services. A SEALDD client may receive a first request for data delivery service from an application comprising information for configuring data transmission measurements (DTM) or an action guarantee for the data delivery service. The SEALDD client may send a second request to a SEALDD server comprising a configuration for enabling at least one of data transmission measurements or an action guarantee. The SEALDD client may receive a first response to the second request that comprises a DTM configuration to configure the SEALDD client to collect data transmission information and may send a second response to the application that comprises information received in the first response. The SEALDD client may collect data transmission measurements during application data traffic, may receive a DTM report for the configured measurements, and may send a DTM report for the configured measurements.

### CROSS-REFERENCE TO RELATED APPLICATIONS

This application claims the benefit of U.S. Provisional patent application Ser. No. 63/371,270, filed Aug. 12, 2022, which is hereby incorporated by reference in their entirety.

### BACKGROUND

In order for the Service Enabler Architecture Layer for Verticals (SEAL) Data Delivery (SEALDD) layer to provide data delivery services to meet the requirements of vertical applications, both a SEALDD client and a SEALDD server may need to know the performance characteristics of the underlying network. However, the existing network performance measurement does not account for the entire path between the SEALDD client and the SEALDD server. Further, there is no exposure of the data transmission measurements from the SEALDD layer to the Vertical Application Layer (VAL) to assist VAL applications with selecting the necessary data delivery services in the network (including the service enablement layer) to ensure the VAL functional goals. Accordingly, there is a need for improved SEALDD procedures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Methods are described herein for SEALDD servers and clients. The methods described herein may apply to data transmission measurement and data delivery services. In one example method, a SEALDD client may receive a first request for data delivery service from an application. The first request may include information for configuring data transmission measurements (DTM) and/or action guarantee for the data delivery service. The SEALDD client may send a second request to a SEALDD server. The second request may include a configuration for enabling at least one of data transmission measurements or action guarantee. The SEALDD client may receive a first response to the second request. The response may include a DTM configuration to configure the SEALDD client to collect data transmission information. The SEALDD client may send a second response to the application. The response includes information received in the first response. The SEALDD client may collect data transmission measurements during application data traffic. The SEALDD client may receive a DTM report for the configured measurements at configured intervals. The SEALDD client may send a DTM report for the configured measurements at configured intervals.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 is a system diagram of an example machine-to-machine (M2M), Internet of Things (IoT), or Web of Things (WoT) communication system in which one or more disclosed embodiments may be implemented;

FIG. 2 is a system diagram of an example architecture that may be used within the M2M/IoT/WoT communications system illustrated in FIG. 1;

FIG. 3 is a system diagram of an example communication network node, such as an M2M/IoT/WoT device, gateway, or server that may be used within the communications system illustrated in FIGS. 1 and 2;

FIG. 4 is a block diagram of an example computing system in which a node of the communication system of FIGS. 1 and 2 may be embodied;

FIG. 5 shows an example SEALDD Architecture;

FIG. 6 shows an example SEALDD Application Traffic Transfer;

FIG. 7 shows an example SEALDD server discovery and selection for data traffic transfer;

FIG. 8 shows an example Non-Roaming 5G System Architecture;

FIG. 9 shows an example Data Transmission Measurement SEALDD Server Discovery Procedure;

FIG. 10 shows an example SEALDD Data Transmission Measurement Enablement;

FIG. 11 shows an example Generic SEALDD Data Transmission Measurement Procedure;

FIG. 12 shows an example SEALDD Data Transmission Measurement Exposure;

FIG. 13 shows an example SEALDD Action Guarantee using User Plane Modification;

FIG. 14 shows an example SEALDD Action Guarantee using Redundant Transport;

FIG. 15 shows an example SEALDD Action Guarantee using SEALDD Data Storage or Caching;

FIG. 16 shows an example SEALDD Action Guarantee using SEALDD Forwarding Proxy;

FIG. 17 shows an example Autonomous SEALDD Action Guarantee initiated by SEALDD Server; and

FIG. 18 shows an example GUI.

### DETAILED DESCRIPTION OF ILLUSTRATIVE EMBODIMENTS

Methods and apparatuses are described herein for SEALDD servers and clients communications. For example, the methods described herein may apply to data transmission measurement and data delivery services.

The following definitions and abbreviations are described herein:

| | |
|---|---|
| 3GPP | Third Generation Partnership Project |
| 5GS | 5G System |
| AF | Application Function |
| API | Application Programming Interface |
| AS | Application Server |
| DNS | Domain Name System |
| DTM | Data Transmission Measurement |
| EAS | Edge Application Server |
| EEC | Edge Enabler Client |
| EES | Edge Enabler Server |
| FQDN | Fully Qualified Domain Name |
| GUI | Graphical User Interface |
| LADN | Local Area Data Network |
| MNO | Mobile Network Operator |
| NEF | Network Exposure Function |
| NWDAF | Network Data Analytics Function |
| OAM | Operation, Administration and Maintenance |
| PCF | Policy Control Function |
| QoE | Quality of Experience |
| QoS | Quality of Service |
| RAN | Radio Access Network |
| SEAL | Service Enabler Architecture Layer for |
| | Verticals |
| SEALDD | SEAL Data Delivery |
| SMF | Session Management Function |
| UE | User Equipment |
| UPF | User Plane Function |
| URI | Uniform Resource Identifier |
| VAL | Vertical Application Layer |

Action Guarantee: An action a SEALDD server performs to ensure a SEALDD connection is providing the level of data delivery service that meets the QoS requirements of the application traffic.

Data Transmission Measurement: Data transmission measurement represents the end-to-end measurement obtained at the SEALDD layer between a SEALDD client and a SEALDD server.

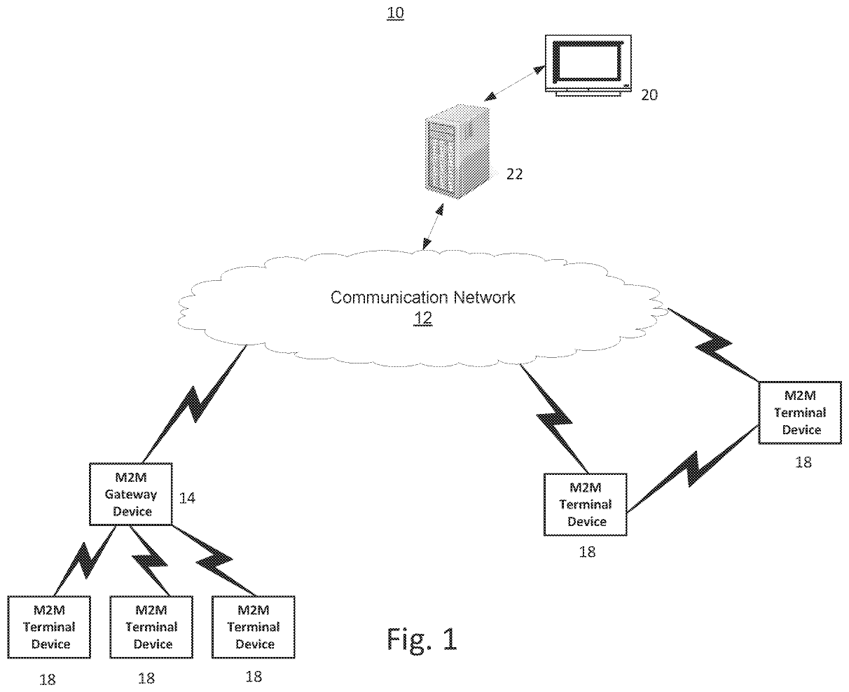

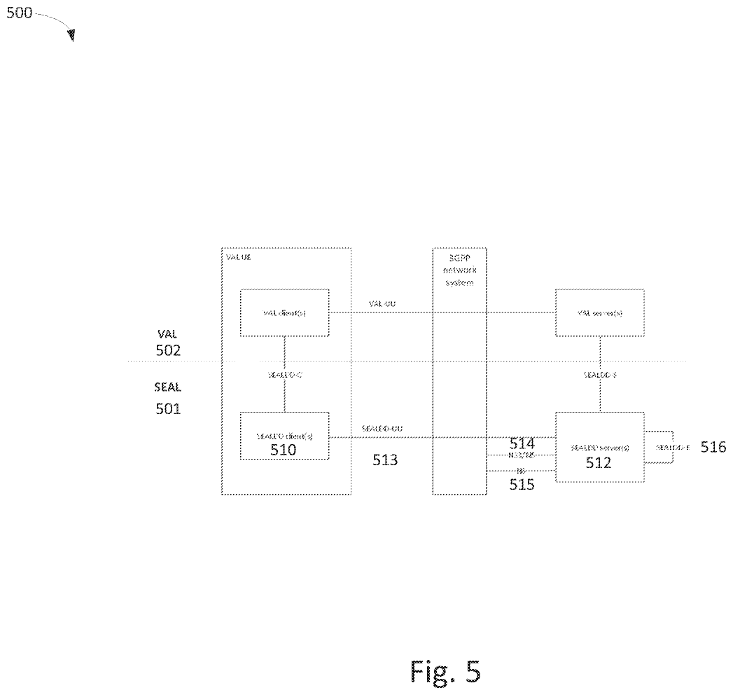

FIG. 1 is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, M2M gateway, M2M server, or M2M service platform may be a component or node of the IoT/WoT as well as an IoT/WoT Service Layer, etc. Any of the client, proxy, or server devices illustrated in any of FIGS. 5-18 may comprise a node of a communication system, such as the ones illustrated in FIGS. 5-18.

The service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above mentioned capabilities or functionalities, supported by the service layer, which can be referred to as a CSE or SCL. A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities.

As shown in FIG. 1, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may be comprised of multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 1, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different nodes (e.g., servers, gateways, device, and the like) of the network. For example, the Field Domain may include M2M gateways 14 and devices 18. It will be appreciated that any number of M2M gateway devices 14 and M2M devices 18 may be included in the M2M/IoT/WoT communication system 10 as desired. Each of the M2M gateway devices 14 and M2M devices 18 are configured to transmit and receive signals, using communications circuitry, via the communication network 12 or direct radio link. A M2M gateway 14 allows wireless M2M devices (e.g., cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or other M2M devices 18. The M2M devices 18 may also receive data from the M2M application 20 or an M2M device 18. Further, data and signals may be sent to and received from the M2M application 20 via an M2M Service Layer 22, as described below. M2M devices 18 and gateways 14 may communicate via various networks including, cellular, WLAN, WPAN (e.g., Zigbee, 6LoWPAN, Bluetooth), direct radio link, and wireline for example. Exemplary M2M devices include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

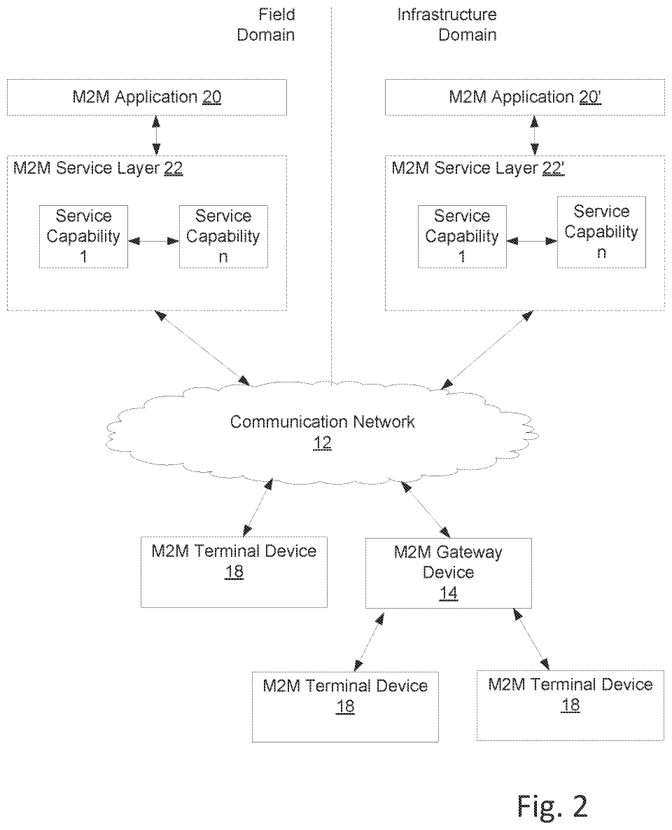

Referring to FIG. 2, the illustrated M2M Service Layer 22 in the field domain provides services for the M2M application 20, M2M gateways 14, and M2M devices 18 and the communication network 12. It will be understood that the M2M Service Layer 22 may communicate with any number of M2M applications, M2M gateways 14, M2M devices 18, and communication networks 12 as desired. The M2M Service Layer 22 may be implemented by one or more nodes of the network, which may comprise servers, computers, devices, or the like. The M2M Service Layer 22 provides service capabilities that apply to M2M devices 18, M2M gateways 14, and M2M applications 20. The functions of the M2M Service Layer 22 may be implemented in a variety of ways, for example as a web server, in the cellular core network, in the cloud, etc.

Similar to the illustrated M2M Service Layer 22, there is the M2M Service Layer 22′ in the Infrastructure Domain. M2M Service Layer 22′ provides services for the M2M application 20′ and the underlying communication network 12 in the infrastructure domain. M2M Service Layer 22′ also provides services for the M2M gateways 14 and M2M devices 18 in the field domain. It will be understood that the M2M Service Layer 22′ may communicate with any number of M2M applications, M2M gateways and M2M devices. The M2M Service Layer 22′ may interact with a Service Layer by a different service provider. The M2M Service Layer 22′ may be implemented by one or more nodes of the network, which may comprise servers, computers, devices, virtual machines (e.g., cloud computing/storage farms, etc.) or the like.

Referring also to FIG. 2, the M2M Service Layers 22 and 22′ provide a core set of service delivery capabilities that diverse applications and verticals may leverage. These service capabilities enable M2M applications 20 and 20′ to interact with devices and perform functions such as data collection, data analysis, device management, security, billing, service/device discovery, etc. Essentially, these service capabilities free the applications of the burden of implementing these functionalities, thus simplifying application development and reducing cost and time to market. The Service Layers 22 and 22′ also enable M2M applications 20 and 20′ to communicate through various networks such as network 12 in connection with the services that the Service Layers 22 and 22′ provide.

The M2M applications 20 and 20′ may include applications in various industries such as, without limitation, transportation, health and wellness, connected home, energy management, asset tracking, and security and surveillance. As mentioned above, the M2M Service Layer, running across the devices, gateways, servers and other nodes of the system, supports functions such as, for example, data collection, device management, security, billing, location tracking/geofencing, device/service discovery, and legacy systems integration, and provides these functions as services to the M2M applications 20 and 20′.

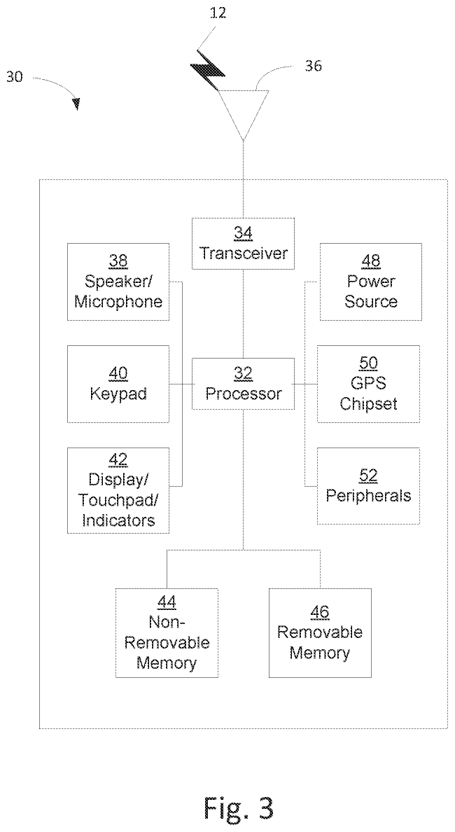

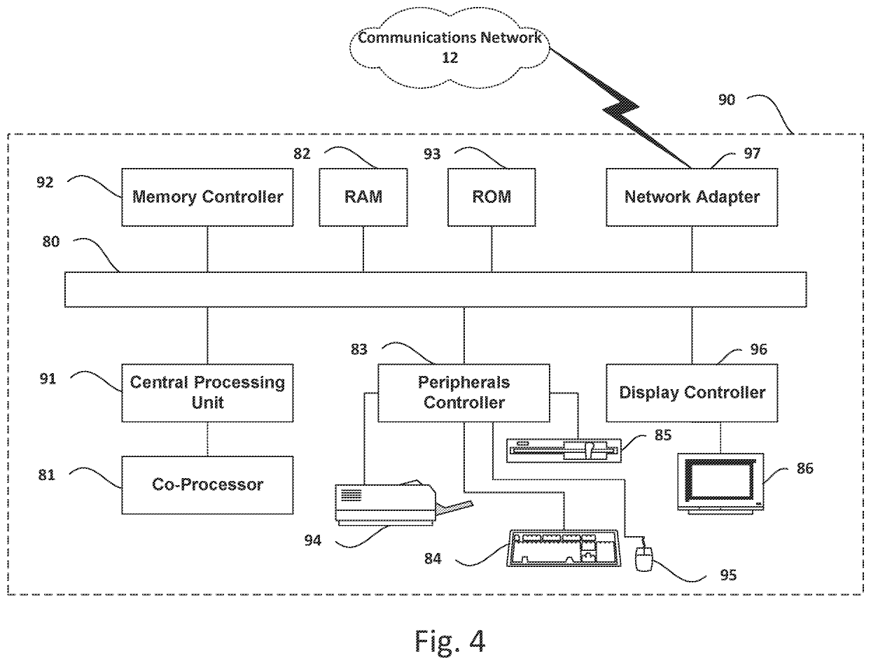

Generally, a Service Layer, such as the Service Layers 22 and 22′ illustrated in FIG. 2, defines a software middleware layer that supports value-added service capabilities through a set of Application Programming Interfaces (APIs) and underlying networking interfaces. Both the ETSI M2M and oneM2M architectures define a Service Layer. ETSI M2M's Service Layer is referred to as the Service Capability Layer (SCL). The SCL may be implemented in a variety of different nodes of the ETSI M2M architecture. For example, an instance of the Service Layer may be implemented within an M2M device (where it is referred to as a device SCL (DSCL)), a gateway (where it is referred to as a gateway SCL (GSCL)) and/or a network node (where it is referred to as a network SCL (NSCL)). The oneM2M Service Layer supports a set of Common Service Functions (CSFs) (i.e., service capabilities). An instantiation of a set of one or more particular types of CSFs is referred to as a Common Services Entity (CSE) which may be hosted on different types of network nodes (e.g., infrastructure node, middle node, application-specific node). The Third Generation Partnership Project (3GPP) has also defined an architecture for machine-type communications (MTC). In that architecture, the Service Layer, and the service capabilities it provides, are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the Service Layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a Service Layer or component thereof may be implemented in the form of software running on a network node (e.g., server, computer, gateway, device or the like) having the general architecture illustrated in FIG. 3 or FIG. 4 described below.

Further, the methods and functionalities described herein may be implemented as part of an M2M network that uses a Service Oriented Architecture (SOA) and/or a Resource-Oriented Architecture (ROA) to access services.

FIG. 3 is a block diagram of an example hardware/software architecture of a node of a network, such as one of the clients, servers, or proxies illustrated in FIGS. 5-18, which may operate as an M2M server, gateway, device, or other node in an M2M network such as that illustrated in FIGS. 5-18. As shown in FIG. 3, the node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements the methods described herein, e.g., in relation to the methods described in reference to FIGS. 5-18 or the data structures of FIGS. 5-18, Tables 1-9, or in a claim.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 3, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the methods described herein, e.g., in relation to FIGS. 5-18, or in a claim. While FIG. 3 depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 3 as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include various sensors such as an accelerometer, biometrics (e.g., finger print) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The node 30 may connect to other components, modules, or systems of such apparatuses or devices via one or more interconnect interfaces, such as an interconnect interface that may comprise one of the peripherals 52.

FIG. 4 is a block diagram of an exemplary computing system 90 which may also be used to implement one or more nodes of a network, such as the clients, servers, or proxies illustrated in FIGS. 5-18, which may operate as an M2M server, gateway, device, or other node in an M2M network such as that illustrated in FIGS. 5-18.

Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 and/or coprocessor 81 may receive, generate, and process data related to the disclosed systems and methods for E2E M2M Service Layer sessions, such as receiving session credentials or authenticating based on session credentials.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adaptor 97, that may be used to connect computing system 90 to an external communications network, such as network 12 of FIGS. 1-4, to enable the computing system 90 to communicate with other nodes of the network.

The SEAL Data Delivery (SEALDD) Architecture is described herein. 3GPP has defined a Service Enabler Architecture Layer for Verticals (SEAL) to provide a horizontal layer in which common services are made available to vertical application layers. Common services offered by SEAL include but are not limited to location management, group management, configuration management, identity management, key management, and network resource management. Vertical Application Layer (VAL) clients may access the SEAL services, which may transport the application traffic to VAL servers over the SEAL layer. In Release 18, 3GPP has decided to enhance the SEAL layer to support efficient data distribution, delivery, and caching towards the application layer. 3GPP TR 23.700-34 captures the work done in the SEALDD study to enhance the SEAL layer with data delivery services.

FIG. 5 shows the proposed SEALDD architecture 500. This architecture 500 may be found in 3GPP TR 23.700-34. In the architecture 500, at the SEAL layer 501, SEALDD clients 510 and SEALDD servers 512 may provide the data delivery service over the SEALDD-UU interface 513 for application traffic transfer from the VAL layer 502. In addition, the SEALDD server 512 may have access to exposure information available from the 3GPP network through the N33/N5 514 and N6 515 interfaces and may have the capability to communicate with other SEALDD servers via the SEALDD-E interface 516. The SEALDD server 512 may access performance statistics from a Network Data Analytics Function (NWDAF) through a Network Exposure Function (NEF) over the N33 interface 514, may configure network parameters to the Policy Control Function (PCF) over the N5 interface 514, and may obtain data traffic measurements from the User Plane Function (UPF) over the N6 interface 516.

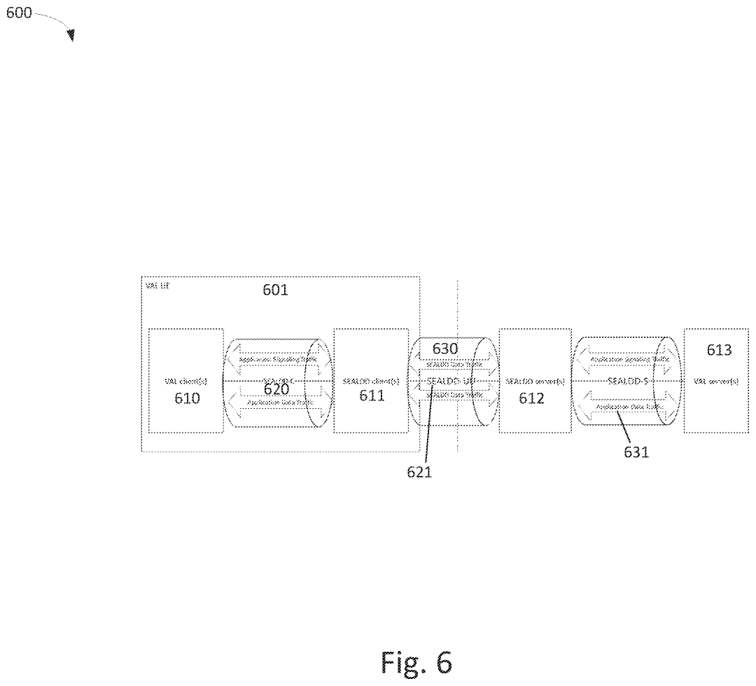

FIG. 6 shows an example of the SEALDD architecture offering vertical applications end-to-end data delivery service 600. The example of FIG. 6 can be found in 3GPP TR 23.700-34. A VAL client 610 on a user equipment (UE) 601 may request SEALDD services from a SEALDD client 611 over the SEALDD-C interface 620. The SEALDD client 611 may route the application traffic to a SEALDD server 612 over the SEALDD-UU interface 621, which may span over multiple network nodes. Upon receiving the SEALDD data traffic 630, the SEALDD server 612 may forward the application data traffic 631 to the corresponding VAL server 613.

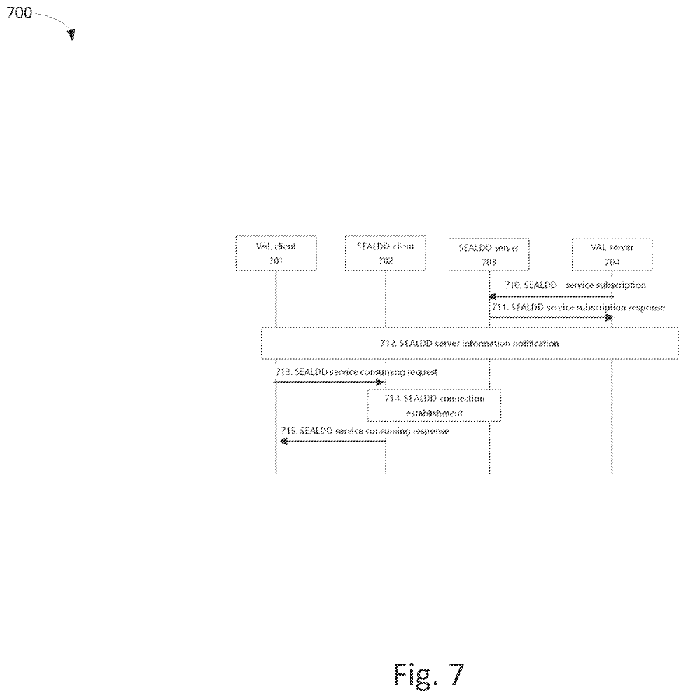

FIG. 7 shows a proposed solution for SEALDD server discovery and selection for data traffic transfer 700. This example is from 3GPP TR 23.700-34. A VAL server 704 may subscribe to SEALDD service from a SEALDD server 703 by sending a SEALDD service subscription request 710 and receiving a SEALDD service subscription response 711. SEALDD server information 712 may be provided to a VAL client 701 via application layer signaling. The VAL client 701 may provide a SEALDD client 702 with the SEALDD server information when requesting SEALDD service 713, and the SEALDD client 701 may use the information to establish a SEALDD connection 714 with the SEALDD server 703. The SEAL client 701 may send a SEALDD service consuming response to the VAL client 701.

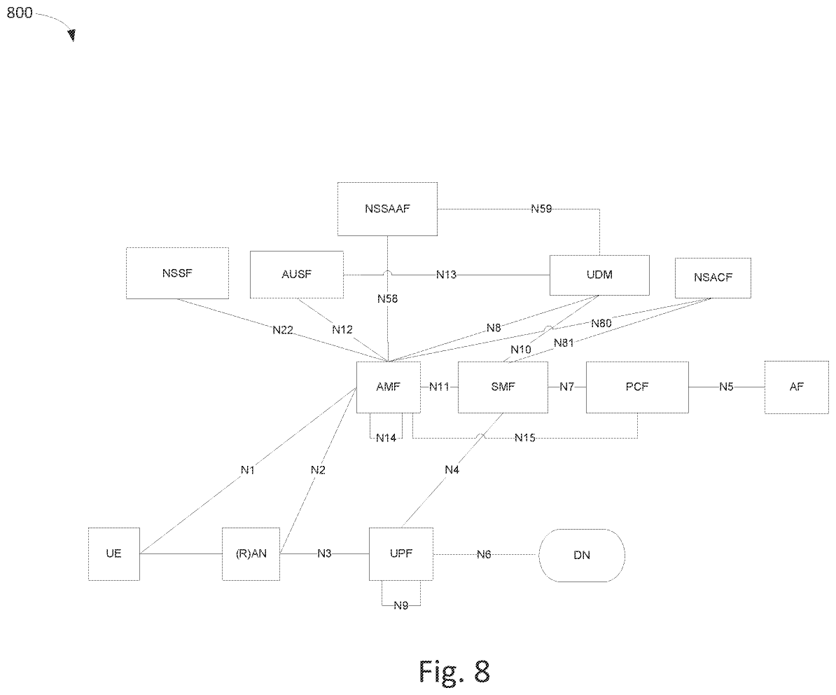

FIG. 8 shows the 3GPP 5G non-roaming system architecture in reference point representation 800. This example is from 3GPP TR 23.501. A UE may communicate with the 5G network to establish control plane signaling and enable the UE to use services from the 5G network. In addition, a UE may also establish user plane sessions to communicate with other UEs or application servers in a Data Network (DN). The user plane includes the path from the UE to the Radio Access Network (RAN) node, through the User Plane Function (UPF), and to the DN where application servers and other UEs may be reached. Network performance measurements may be obtained for the path between the UE and the RAN node and for the path between the UE and the UPF.

Traditionally, network performance is measured between two endpoints, and it may be used to specify the service quality of a network between the endpoints. The main aspects of network performance measurements may include but are not limited to data rate, latency, and data loss. Data rate can be measured as the network throughput, which represents the actual data rate that may be transferred by the network over a particular time period between the two endpoints. Latency may be represented as the round-trip time of a data packet and also the jitter experienced by a recipient in the form of the variance in packet delays among different packets. Data loss, which may also be referred to as network errors, may be characterized by the packet lost rate as measured by the recipient and by the retransmission rate as measured by the sender. The aforementioned measurements may rely on a network connection between the two endpoints. Therefore, connection availability may also be considered a measurement pertinent to network performance measurements. Finally, the performance measurements may then serve as inputs for the calculation of Quality of Service (QoS) that the network provides or Quality of Experience (QoE) that a user experiences.

In order for the SEALDD layer to provide data delivery services to meet the requirements of vertical applications, both a SEALDD client and a SEALDD server may need to know the performance characteristics of the underlying network. 3GPP TR 23.700-34 has identified a key issue to add support of data transmission quality measurement and guarantee to the SEALDD layer. Currently, the SEALDD server may already have access to performance measurements from the 5G network, but the measurements only indicate the performance within the 5G network (e.g., the traffic between a UE and a UPF) and does not extend to the end-to-end performance between the SEALDD client and the SEALDD server. Therefore, the network performance measurement does not account for the entire path between the SEALDD client and the SEALDD server.

The overall end-to-end data delivery path between a VAL client and a VAL server is shown in FIG. 6 as described above. The true quality of the data delivery service for the application traffic can be measured in an end-to-end fashion as the data originates in the VAL client and terminates at the VAL server (or vice versa). Therefore, data transmission measurements obtained for the end-to-end path may be reflected in the user experience. In such a scenario, the SEALDD server may be co-located with the VAL server or be deployed sufficiently close to the VAL server such that network delays are minimal.

Currently, there may be no exposure of the data transmission measurements from the SEALDD layer to the VAL layer to assist VAL applications with selecting the necessary data delivery services in the network (including the service enablement layer) to ensure the VAL functional goals. If more than one SEALDD server is available, a VAL application may not be able to determine whether the SEALDD server can provide the desired services or levels of service required by the VAL application. This may cause unintended interruptions to the application traffic and reduce the quality of experience for the user.

Finally, the SEALDD layer may be able to address issues with network congestion by performing actions to ensure a SEALDD connection is providing the level of data delivery service that meets the QoS requirements of the application traffic. The data transmission measurements may be used by SEALDD clients and SEALDD servers to monitor the quality of a SEALDD connection, and if the measurements indicate possible network congestion issues, the SEALDD client and/or server may perform actions to modify user plane resources in the 5G network or use redundant transports or other SEALDD capabilities to try to improve the quality of the SEALDD connection.

The SEALDD layer may provide a data delivery service to vertical applications that may directly impact the user experience. Therefore, the ability to obtain end-to-end data transmission measurements at the SEALDD layer may assist SEALDD clients and servers to better provide the data delivery service. The data transmission measurements may provide insight into network congestion and allow the SEALDD server to perform action guarantee to preserve the QoS requirement of the data delivery service. The SEALDD layer may also expose the data transmission measurement to vertical applications to enhance overall SEALDD data delivery service.

Embodiments are described herein that are directed to:

A method for a SEALDD client to:
Receive a first request for data delivery service from an application, the first request may include information for configuring data transmission measurements (DTM) and/or action guarantee for the data delivery service;
Send a second request to a SEALDD server, the second request includes a configuration for enabling at least one of data transmission measurements or action guarantee;
Receive a first response to the second request, the response includes a DTM configuration to configure the SEALDD client to collect data transmission information;
Send a second response to the application, the response includes information received in the first response;
Collect data transmission measurements during application data traffic;
Receive a DTM report for the configured measurements at period intervals; and
Send a DTM report for the configured measurements at period intervals.

A method for a SEALDD server to:
Receive a configuration for data transmission measurement (DTM) and action guarantee;
Send a DTM report and include the configured data transmission measurements;
Receive a request to perform an action guarantee; and
Perform the requested action guarantee, which comprise one or more of modifying user plane, establishing redundant transport, using data storage, data caching, or forwarding proxy capability.

A method for a SEALDD client to:
Send a request to an edge enabler client with a list of data transmission measurements the SEALDD client supports; and
Receive a response from the edge enabler client with a list of SEALDD servers, the list of SEALDD servers include a list of data transmission measurements each SEALDD server supports with DTM configurations and a list of action guarantees that can be performed by each SEALDD server.

A process of enabling data transmission measurements at the SEALDD layer to enhance and optimize data delivery services is described herein. The SEALDD server discovery procedure can be enhanced for SEALDD clients to discover SEALDD servers that support data transmission measurements. Alternatively, the SEALDD clients may be provisioned with information about the SEALDD servers. Various data transmission measurements applicable to the SEALDD layer may be described to show the end-to-end interactions. The data transmission measurements may be incorporated with action guarantees performed within the SEALDD layer in response to network congestion and to enable the optimization of application traffic transport. The action guarantees may use other SEALDD services that may be available, such as the use of redundant transport, SEALDD data storage or caching, and SEALDD server forwarding proxy.

SEALDD server discovery enhancements for data transmission measurement are described herein. Obtaining data transmission measurements requires the support from both the SEALDD client as well as the SEALDD server. Prior to the enablement of such measurements, a SEALDD client may first discover a SEALDD server that supports data transmission measurements. There are various ways a SEALDD client discovers a SEALDD server and each is described hereinafter. Note that a VAL server or another SEALDD server may also discover data transmission measurement capability of a SEALDD server as well.

3GPP TR 23.700-34 describes a SEALDD server discovery and selection procedure, as shown in FIG. 7, in which a VAL server subscribes to a SEALDD server and provides the SEALDD server information to the SEALDD client via application layer signaling. During this procedure, the VAL server may have obtained the capabilities of the SEALDD server. One such capability may be the SEALDD server's support of data transmission measurements and action guarantee as further outlined in this disclosure. The VAL server may forward the SEALDD server's support of data transmission measurements and action guarantee to the SEALDD client, and the SEALDD client may utilize the information to enable the collection of the desired data transmission measurement(s) and to request action guarantee when necessary.

In another embodiment, a SEALDD server may be discovered by a SEALDD client as part of Edge Application Server (EAS) discovery procedure at an edge data network. The EAS discovery procedure is described in 3GPP TS 23.558. The SEALDD server, operating as an EAS, first registers with an Edge Enabler Server (EES) with an indication of support for data transmission measurements and action guarantee. Then an Edge Enabler Client (EEC) on a UE may discover the SEALDD server using the EAS discovery procedure and may obtain the capability of the SEALDD server, upon which the information may be made available to the SEALDD client.

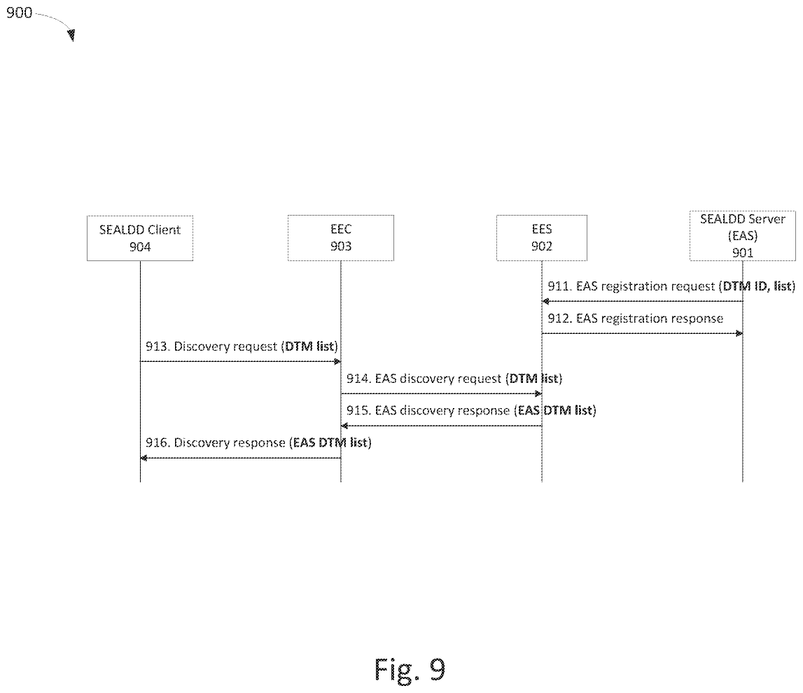

FIG. 9 shows an example of an enhancement to SEALDD server discovery procedure 900 in which a SEALDD client may discover SEALDD servers that support data transmission measurements and action guarantee.

At step 911, SEALDD server 901 may operate as an EAS and may provide an EAS profile with a data transmission measurement identifier in an EAS registration request. The EAS profile may also include a list of data transmission measurements that the SEALDD server 901 supports as well as possible configurations for the data transmission measurements. In addition, the SEALDD server 901 may also include the action guarantees that it supports.

At step 912, an Edge Enabler Server (EES) 902 may perform an authorization check to verify whether the EAS is authorized to register to the EES. If the EAS is authorized, the EES 902 may store the EAS profile and return a response to the SEALDD server 901. The response may include a status for the request and an expiration for the registration. Note that the EES 902 may receive registration requests from multiple EASs (e.g. SEALDD servers) with their EAS profiles.

At step 913, the SEALDD client 904 may send a discovery request to an Edge Enabler Client (EEC) 903. The request may include a list of data transmission measurements the SEALDD client supports for the EEC 903 to discover SEALDD server(s) that matches the provided data transmission measurements.

At step 914, the EEC 903 may send an EAS discovery request to the EES 902, the request may include discovery filters that may contain the data transmission measurements provided by the SEALDD client 904.

At step 915, the EES 902 may check if the EEC 903 is authorized to discover the EASs. If authorized, the EES 902 may search for EASs that support the data transmission measurements provided in the discovery filters. The FES 902 may return a list of FASs that supports the requested data transmission measurements and information from the corresponding EAS profile. For each EAS, the EES 902 may include DTM identifiers, a list of data transmission measurements and the applicable configuration if it is available, and a list of action guarantees.

At step 916, the EEC 903 may return the list of EASs and related information received from the EES 902 to the SEALDD client 904.

In the this example, the discovery of a SEALDD server that supports data transmission measurement by a SEALDD client depends on the information of the capability of the SEALDD server. This information may comprise of various information that describes what types of performance measurements are supported as well as the available measurement configuration and a list of action guarantees.

SEALDD end-to-end data transmission measurements are described herein. After the discovery of DTM support by SEALDD servers, a SEALDD client may request to enable data transmission measurements during the establishment or update of a SEALDD connection with the SEALDD server. This may be referred to herein as SEALDD DTM enablement. The SEALDD client may also include a list of data transmission measurements that it supports in the request to enable the SEALDD server to configure DTM measurement collection and reporting from the SEALDD client in the connection response. DTM collection may be integrated with application data transfers to provide a measure of responsiveness that the SEALDD connection provides. The responsiveness measure may indicate the quality of the underlying network between the SEALDD client and the SEALDD server. Note that SEALDD DTM enablement may also occur between two SEALDD servers to exchange DTM capabilities. In that scenario, DTM enablement may be integrated as part of SEALDD server discovery or be configured by an operator policy, a server administrator, or an OAM management node.

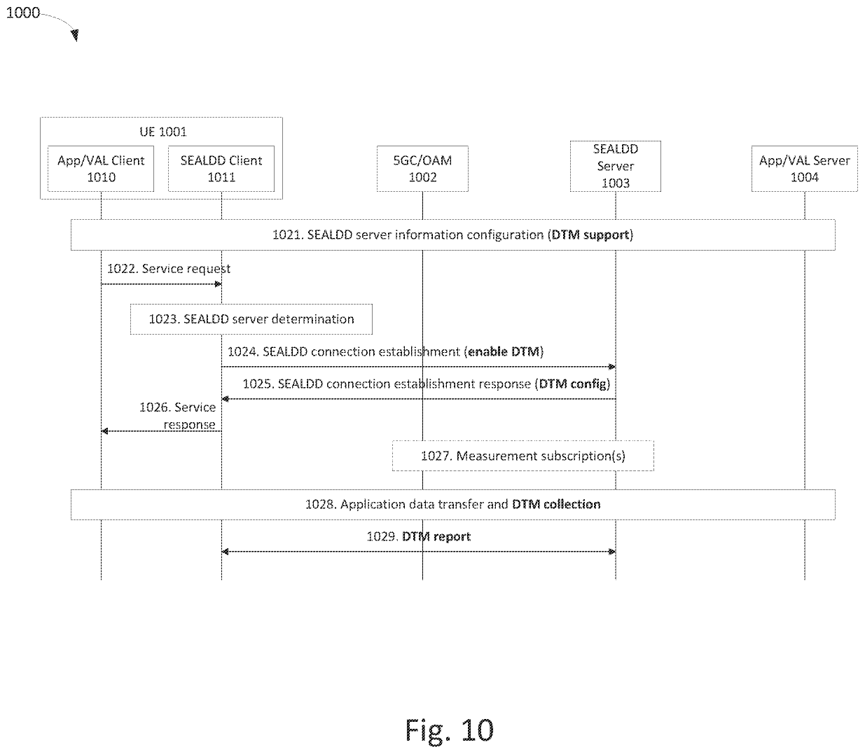

FIG. 10 shows an example procedure 1000 for SEALDD Data Transmission Measurement (DTM) enablement. At step 1021, a SEALDD client 1011, of the UE 1001, may be configured with SEALDD server contact information and associated SEALDD capabilities, including whether the SEALDD server supports data transmission measurements. The configuration may be provided as part of SEALDD server discovery, user or service provider configuration, through application layer traffic, etc. For SEALDD service that may require authorization, e.g. for the use of redundant transport services, the SEALDD client 1011 may be notified that it is authorized to use such services. The SEALDD client 1011 may be configured with information indicating one or more SEALDD servers.

At step 1022, a VAL client 1010, of the UE 1001, may make a request for a SEALDD data delivery service and may provide information about the application with the desired QoS requirements. The request may include an application identifier, the desired QoS, whether and what data transmission measurements to enable, data transmission measurement configuration information, and a list of one or more action guarantees with corresponding triggering events. Action guarantee is described in more detail in the action guarantee procedures. The data delivery service request may include the use of other SEALDD services, such as the use of redundant transport, SEALDD data storage or caching, and SEALDD server forwarding proxy.

At step 1023, the SEALDD client 1011 may make a determination on which SEALDD server is best to provide the SEALDD data delivery service based on the information provided by the VAL client 1010. The SEALDD client 1011 may also choose SEALDD servers that support data transmission measurements in order to monitor and manage the SEALDD connection to provide the desired service to the VAL client.

At step 1024, the SEALDD client 1011 may establish a SEALDD connection with the selected SEALDD server 1003 and may provide information to configure and enable data transmission measurement for the SEALDD connection. Examples of the information that can be provided for data transmission measurements are listed in Table 1. The SEALDD client 1011 may specify the data transmission measurements that it supports and configure one or more measurements to be reported by the SEALDD server 1003. The SEALDD client 1011 may also specify whether to enable a measurement schedule for the SEALDD connection in which the SEALDD server 1003 autonomously measures and provides DTM reports to the SEALDD client 1011. For each measurement, the SEALDD client 1011 may specify the identifier for the measurement, the types of measurements to report, measurement and reporting periods schedule, and an expiration for the measurement. Alternatively, the SEALDD client 1011 may also initiate measurement requests explicitly using Explicit mode and if necessary, the Payload size for the measurement requests. Some measurements may require sending multiple requests and/or a total number of requests in order to obtain more meaningful measurements. For these measurements, the Burst size and Total packets informational elements may be configured. In addition, various identifiers may be maintained to provide context for the measurement configuration. Examples of such identifiers may be a DTM configuration identifier, a SEALDD connection identifier, an application identifier, and identifiers for application types. The SEALDD client 1011 may also request the use of other SEALDD services, such as the use of redundant transport, SEALDD data storage or caching, and SEALDD server 1003 forwarding proxy. The configuration for the SEALDD services is shown in Table 9 and will be described in more detail in the action guarantee procedures.

TABLE 1
Data Transmission Measurement Configuration Information

| Informational | |
|---|---|
| Element | Parameter Description |
| Connection identifier | Specifies the SEALDD connection identifier for the |
| | configuration |
| DTM configuration | An identifier for the DTM configuration |
| identifier | |
| Application identifiers | Specifies application IDs that may be carried by the |
| | SEALDD connection |
| Application types | Specifies application types that may use the measurements in |
| | this configuration |
| Measurement | |
| Configuration | |
| >Identifier | An identifier for the data transmission measurement that a |
| | SEALDD client/server selects. Examples may include |
| | Connection Availability, Throughput, Round-Trip Time |
| | (RTT), Jitter, Packet Rate Loss, Retransmission Rate, etc. If |
| | supported, network performance measurements from the 5G |
| | network, statistics from analytics functions, and other |
| | information (e.g. from management OAM nodes) may be |
| | specified. |
| >Types | A list of the types of measurement values that are requested. |
| | The measurement type can be current value (e.g. last value |
| | or moving average value), minimum, maximum, average, |
| | normalize, etc. |
| >Burst size | If measurements are to be sent in a burst, specifies the |
| | number of measurement requests in a burst |
| >Total packets | For measurements that may require total number of packets |
| | in their calculations, specifies the number of packets to send |
| | for the calculation |
| >Schedule | Configuration of a measurement period to obtain the data |
| | transmission measurement autonomously (e.g. automatic |
| | stop and restart of measurement timer) |
| >Reporting | Configuration of the reporting period in which DTM reports |
| | are sent |
| >Expiration | Configuration in which the data transmission measurement |
| | expires |
| >Explicit mode | Specifies the mode of explicit measurement signaling: start |
| | measurement, continue measurement, report and continue |
| | measurement, report and reset measurement, report and stop |
| | measurement. |
| >Payload size | If using explicit measurement signaling, specifies the size in |
| | bytes of the payload |

The configuration information shown in Table 1 may be exposed to VAL applications, SEALDD clients and servers, and other network nodes such as analytic clients and servers to provide access and configuration of the supported data transmission measurements. In turn, the data transmission measurements may provide information as to the quality or responsiveness of a SEALDD connection. VAL applications may use the measurements to determine suitable SEALDD services for a particular application and analytic servers may use the measurements to generate statistics and predictions of SEALDD communications in a particular area and/or for a particular time period.

At step 1025, the SEALDD server 1003 may return a status to the SEALDD connection establishment request and may include DTM configuration information for the SEALDD client 1011. The DTM configuration may configure the SEALDD client 1011 to collect data transmission information and also includes updates to the DTM configuration for the SEALDD server 1003. The SEALDD server 1003 may also return any of the identifiers listed in Table 1 if they were not present in step 1024. Separate DTM identifiers may be provided-one identifier for the SEALDD server configuration and another identifier for the SEALDD client configuration. The DTM configuration for the SEALDD server may determine what measurements the SEALDD server may collect and may report while the DTM configuration for the SEALDD client may determine what measurements the SEALDD client may collect and may report. If the SEALDD client had requested the use of other SEALDD services, the SEALDD server may also return action guarantee configuration information as shown in Table 9 in the response message. For example, the SEALDD server may return a storage URI, maximum storage size, and an expiration time for when the stored data will be removed if SEALDD data storage or caching capability is configured.

At step 1026, the SEALDD client 1011 may return a response to the VAL client 1010 and include data transmission measurement exposure information the VAL client 1010 can use to monitor the SEALDD connection. The data transmission measurement exposure information may include the measurement configuration shown in Table 1. The VAL client 1010 may use the exposure information to subscribe to receive data transmission measurements from the SEALDD layer.

At step 1027, the SEALDD server 1003 may subscribe to receive notifications from the 5G network or OAM management nodes 1002 to obtain network measurements and/or analytics. For example, the SEALDD server 1003 may subscribe to get user plane measurements from a Session Management Function (SMF) or from a User Plane Function (UPF). The SEALDD server 1003 may also subscribe to obtain analytic statistics or predictions from a Network Data Analytics Function (NWDAF) or other network functions in the 5G system. If authorized and appropriate, the SEALDD server 1003 may also subscribe to obtain RAN level measurements and performance measurements from OAM management nodes. These measurements may be used by the SEALDD server 1003 to assist in determining where network congestion may be when SEALDD data delivery service is not providing the appropriate QoS.

At step 1028, application data traffic may be sent through the SEALDD data delivery connection and if configured, the SEALDD client 1011 and the SEALDD server 1003 may collect and process data for reporting data transmission measurements.

At step 1029, at the configured measurement reporting intervals, the SEALDD client 1011 and the SEALDD server 1003 may submit DTM reports containing the data transmission measurements that have been enabled and other information as shown in Table 2. For each configured measurement, the DTM report may contain the measurement identifier, the source of the measurement, the measurement period, and one or more types of measurement requested. The DTM report may also contain a report identifier, a SEALDD connection identifier, an application identifier, a timestamp for the report, and a connection quality metric for the SEALDD connection. The connection quality metric may be generated from various sources that the SEALDD server 1003 and/or client may have obtained, including information obtained from an analytics function, from the 5G network, or from an OAM management node 1002.

To provide additional benefits for other network nodes, subscription/notification mechanisms may be employed for the DTM reports. Analytic servers or other SEALDD servers may subscribe to receive notifications of DTM reports containing certain measurement identifiers and measurement types.

TABLE 2
Data Transmission Measurement Report Information

| Informational Element | Parameter Description |
|---|---|
| Report identifier | An identifier for the DTM report |
| DTM configuration | An identifier for the DTM configuration |
| identifier | |
| Connection identifier | An identifier for the SEALDD connection |
| Application identifier | An identifier for the application traffic carried by the SEALDD |
| | connection |
| Timestamp | The time when the DTM report was generated |
| Connection quality | A metric showing the quality of the SEALDD connection. The |
| | metric may be represented as a string, an alphanumeric value, a |
| | numerical scale, a QoS or QoE value, etc. |
| Measurement(s) | |
| >Identifier | The identifier for the data transmission measurement, e.g. RTT, |
| | packet loss rate, etc. |
| >Source | The source of the measurement. The source can be from the |
| | SEALDD layer (e.g. a SEALDD client or server), from an edge |
| | data network server, from an analytics function, from a |
| | specified network function of the 5G network, from an OAM |
| | management node, etc. The source may be specified as an |
| | identifier or DNS name that may be resolved to an FQDN, an |
| | IP address and port number, a MAC address, etc. |
| >Measurement period | The time period in which the measurement was taken. |
| >Current value | The current (e.g. last value or moving average value) value |
| | associated with the measurement identifier |
| >Avg value | The average value associated with the measurement identifier |
| | during the measurement period. |
| >Min value | The minimum value associated with the measurement identifier |
| | during the measurement period. |
| >Max value | The maximum value associated with the measurement identifier |
| | during the measurement period. |

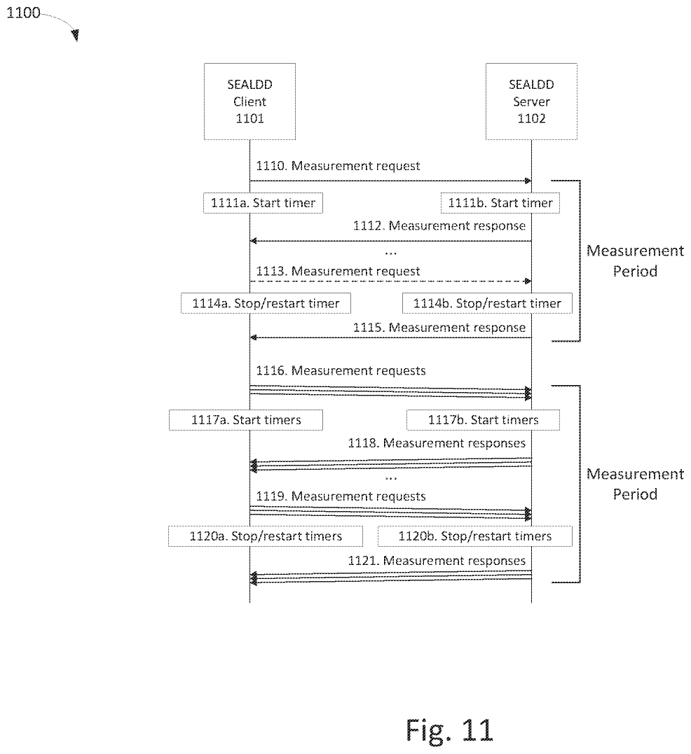

FIG. 11 shows an example SEALDD data transmission measurement procedure 1100. A SEALDD client 1101 or a SEALDD server 1102 may initiate data transmission measurement collection after the DTM enablement procedure completes. FIG. 11 shows a generic procedure in which the SEALDD client may initiate data transmission measurements with a SEALDD server 1102. The measurement requests may include data transmission measurement configuration information as shown in Table 1 to identify which measurements are requested as well as the configuration for obtaining the measurements. Note that even though FIG. 11 shows a SEALDD client 1101 initiating the measurement requests, a SEALDD server may also initiate the same requests to the SEALDD client.

At step 1110, whenever a data transmission measurement is desired, a SEALDD client 1101 may send a request to a SEALDD server 1102 to trigger the start of DTM collection. The request may include measurement configuration information as shown in Table 1 to identify which measurement(s) is being requested.

At step 1111, the request from step 1110 may trigger the start of a measurement timer for time-based measurements such as round-trip time and packet rate loss. The timer may be started in the SEALDD client 1101 (step 1111a) after sending the request in step 1110 and the timer may be started in the SEALDD server 1102 (step 1111b) upon the receipt of the request from step 1110. Data collection for the requested measurement may start.

At step 1112, the SEALDD server 1102 may return a measurement response to the SEALDD client 1101 to acknowledge the start of the collection of the requested measurement(s). The response may include any update to the measurement configuration provided by step 1110 that the SEALDD server 1102 has modified. If the measurement is for connection availability, the response may indicate the SEALDD connection is active and available data transmission measurements may be provided to indicate the quality of the SEALDD connection. For measurements that may be obtained with a single request/response message pair such as round-trip time, the SEALDD server 1102 may provide the measurement in the response.

At steps 1113-1115, steps 1110-1112 may be repeated. In one embodiment, steps 1113-1115 may signify the end of a measurement period and the SEALDD server 1102 may return a DTM report to the SEALDD client 1101 in step 1115. An example of a DTM report is shown in Table 2. If measurement(s) collection is to continue, the measurement request in step 1113 may trigger the stop and restart of the measurement timer in steps 1114a and 1114b. In another embodiment, steps 1113-1115 may signify the end of the measurement collection and the measurement timers are stopped in steps 1114a and 1114b. In both embodiments, the SEALDD server 1102 may return a DTM report to the SEALDD client 1101 in step 1115. When autonomous data transmission measurements are configured, the SEALDD client 1101 and the SEALDD server 1102 may automatically stop and restart the measurement timer in steps 1114a and 1115b respectively based on the schedule information element shown in Table 1. As a result, it may not be necessary for the SEALDD client 1101 to send the request in step 1113. Then at every configured reporting interval, the SEALDD server 1102 may send a DTM report to the SEALDD client 1101 until the expiration of the DTM collection.

At step 1116, the SEALDD client 1101 may send a burst of measurement requests to the SEALDD server 1102 for certain measurements such as throughput and jitter. The measurement requests may include certain size payloads in order for the SEALDD server 1102 to collect and determine the appropriate measurements. Typically, the payloads are zero-padded for the specified size; however, the payload may be actual application data if the measurement requests are integrated with application data transfers. For jitter measurement, an identifier may be included to identify the requests belonging to a burst to enable the SEALDD server 1102 to measure the jitter associated with the requests in the burst.

At steps 1117a and 1117b, the SEALDD client 1101 and SEALDD server 1102 may start one or more measurement timers for each of the configured measurement(s) (similar to steps 1111a and 1111b). One timer may be associated with each request in the burst.

At step 1118, the SEALDD server 1102 may return responses to each of the requests received in step 1116 (similar to step 1112 but applied for a burst of responses).

At steps 1119-1121, the timers associated with each burst request for each configured measurement may be stopped and restarted (Similar to steps 1113-1115 but applied to each request in the burst, steps 1116-1118 may be repeated as steps 1119-1121). Autonomous DTM collection may be configured in which the timers are automatically stopped and restarted and periodic DTM reports are sent to the SEALDD client.

FIG. 11 shows measurement requests/responses as explicit signaling between a SEALDD client 1101 and a SEALDD server 1102 using the established SEALDD connection, transport protocol, and PDU session for the application traffic between the VAL client and the VAL server. To improve efficiency, the measurement requests/responses may be integrated with the application traffic between the SEALDD client 1101 and the SEALDD server 1102. Note that this is possible due to the measurement originating at the SEALDD layer where application data is available. For other network performance measurements, explicit measurement request/response may be required as application data may not be available.

FIG. 11 also shows two methods for requesting measurements: individual request and burst requests. For certain measurements, e.g. connection availability and RTT, individual requests may be sufficient to obtain the necessary measurement values. However, for other measurements such as throughput and jitter, burst requests may be required in order to obtain more meaningful measurements. In addition, measurement requests may be scheduled in an autonomous manner in which the measurement period, reporting period, and measurement expiration may be configured. For measurement scheduling, the SEALDD client 1101 or server 1102 manages the start, stop, and restart of internal timers for the associated measurement periods.

In the following measurement descriptions, example configurations are provided for each measurement. The configuration may be exposed to VAL applications in order for the VAL applications to access and request data transmission measurements from the SEALDD layer. A VAL application may query the SEALDD client or server for available data transmission measurements and the associated configurations. The VAL applications may then explicitly request the desired measurement configurations or the VAL applications may simply request to enable the measurements and let the SEALDD layer manage the measurement configuration.

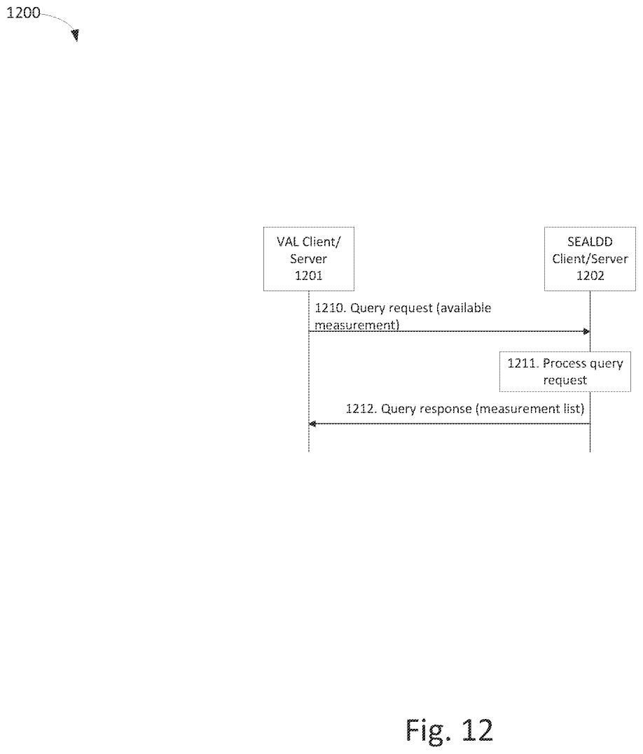

FIG. 12 shows an example procedure 1200 in which a VAL client/server 1201 may query a SEALDD client/server 1202, respectively, for data transmission measurements available to the VAL applications.

At step 1210, a VAL client/server 1201 may send a request to a SEALDD client/server 1202 for available data transmission measurements and the associated configuration.

At step 1211, the SEALDD client/server 1202 process the query request. A SEALDD client may search within internally stored EAS profiles to locate EASs (e.g., SEALDD servers) that support data transmission measurements and their associated configurations. A SEALDD server may compile all the supported data transmission measurements and the associate configuration.

At step 1212, the SEALDD client/server 1202 may return a response with a list of data transmission measurements and the associate configuration. The configuration may include a range for configuring each measurement parameter. The response from the SEALDD client may include available measurements and associated configuration for one or more SEALDD servers, which may indicate the available measurements are supported by both the SEALDD client and the SEALDD servers.

After a VAL client/server 1201 has discovered available data transmission measurements at the SEALDD layer, the VAL client/server 1201 may subscribe to receive notifications for the measurements of a SEALDD connection. A subscription request may include the VAL client/server 1201 identifier, a SEALDD connection identifier, one or more data transmission measurement identifiers, and the conditions for which to received notifications. The conditions may be based on a periodic timer or a measurement threshold value in which notifications are sent if the measurement value exceeds or falls below the threshold value. The VAL client/server 1201 may also specify an expiration time for receiving the notifications.

The connection availability measurement may simply be a request/response mechanism between a SEALDD client and a SEALDD server, or vice versa. The measurement may be realized as a periodic heartbeat or as an echo request to ensure a SEALDD connection is still active. Table 3 shows an example of the configuration for the connection availability measurement with the associated measurement identifier. If the measurement request contains a Request measurements informational element, then it is expected that the recipient may return any available data transmission measurement. If no measurement is available, then the response may indicate none or null. The connection availability may also be scheduled with a periodic measurement period as well as an expiration time. When scheduled, it may be represented as a heartbeat notification sent from the recipient to the requestor to indicate the connection is active.

TABLE 3
Connection Availability Configuration

| Informational | |
|---|---|
| Element | Parameter Description |
| Measurement ID | Connection availability |
| Schedule | Configures a schedule for reporting the |
| | availability of the connection |
| Expiration | Configuration in which the data transmission |
| | measurement expires |
| Request | Specifies a list of current measurements be |
| measurements | provided in the response |

The throughput measurement enables a SEALDD client or a SEALDD server to determine the data rate of a SEALDD connection over a period of time. The throughput measurement may be used to evaluate the bandwidth usage of a SEALDD connection and may help assist in analyzing and/or predicting potential network congestion. The throughput measurement may be configured as shown in Table 4 with the Throughput measurement identifier. A requestor may indicate the types of measurement value to include in a DTM report and the direction of the measurement. The throughput may also be scheduled by providing a measurement period, a reporting period, and an expiration time. When scheduled, the recipient automatically starts, stops, and restarts an internal timer and measures the data rate in bytes recorded for each measurement period. Then at the appropriate reporting period, the recipient sends a DTM report with the requested measurement types. An explicit mode may provide a requestor the ability to control measurement at the recipient to start measurement collection (e.g. to initialize the throughput counter), continue measurement collection, report and continue measurement collection, report and reset measurement collection, and report and stop measurement collection. If the measurement request is an explicit request, then the Payload size may be included to specify how many bytes of data are sent. In addition, a burst size may also be included to specify how many requests are sent in a burst.

TABLE 4
Throughput Measurement Configuration

| Informational | |
|---|---|
| Element | Parameter Description |
| Measurement | Throughput |
| ID | |
| Types | A list of the types of measurement values that are |
| | requested. The measurement type can be current value |
| | (e.g. last value or moving average value), minimum, |
| | maximum, average, normalize, etc. |
| Burst size | If measurements are to be sent in a burst, specifies |
| | the number of measurement requests in a burst |
| Schedule | Configuration of a measurement period to obtain the data |
| | transmission measurement autonomously (e.g. automatic |
| | stop and restart of measurement timer) |
| Reporting | Configuration of the reporting period in which DTM |
| | reports are sent |
| Expiration | Configuration in which the data transmission |
| | measurement expires |
| Explicit mode | Specifies the mode of explicit measurement signaling: |
| | start measurement, continue measurement, report and |
| | continue measurement, report and reset measurement, |
| | report and stop measurement. |
| Payload size | If using explicit measurement signaling, specifies the size |
| | in bytes of the payload |

The round-trip time measurement enables a SEALDD client or a SEALDD server to measure the round-trip delay of SEALDD messages between the SEALDD client and SEALDD server. The RTT delay may be measured with a single request/response message pair or the delay may be measured over a measurement period where the delay may be averaged or post-processed to provide a metric for network latency. Similar to the throughput measurement, the RTT delay measurement may be configured to operate in autonomous or explicit mode. For autonomous mode, a requestor may provide a measurement period, a reporting interval, and an expiration time for the measurement. If desired, a burst size may be specified to provide multiple RTT delay measurements. The same explicit modes may be specified similar to the throughput measurement: start measurement, continue measurement, report and continue measurement, report and reset measurement, and report and stop measurement. The types of reported measurement may consist of current value (e.g. last value or moving average value), minimum value, maximum value, average value, normalized value, etc.

TABLE 5
Round-Trip Time Measurement Configuration

| Informational | |
|---|---|
| Element | Parameter Description |
| Measurement ID | Round-trip time |
| Types | A list of the types of measurement values that are |
| | requested. The measurement type can be current value |
| | (e.g. last value or moving average value), minimum, |
| | maximum, average, normalize, etc. |
| Burst size | If measurements are to be sent in a burst, specifies |
| | the number of measurement requests in a burst |
| Schedule | Configuration of a measurement period to obtain the |
| | data transmission measurement autonomously (e.g. |
| | automatic stop and restart of measurement timer) |
| Reporting | Configuration of the reporting period in which DTM |
| | reports are sent |
| Expiration | Configuration in which the data transmission |
| | measurement expires |
| Explicit mode | Specifies the mode of explicit measurement signaling: |
| | start measurement, continue measurement, report and |
| | continue measurement, report and reset measurement, |
| | report and stop measurement. |
| Payload size | If using explicit measurement signaling, specifies |
| | the size in bytes of the payload |

The jitter measurement may be used to represent the variance in delays among different packets transferred within a SEALDD connection. The recipient in this case may be receiving packets with various delays and out of order from when the packets were sent. As a result, an easy way to configure jitter measurement is to send a burst of requests with the same burst identifier and different packet numbers and let the recipient calculate the jitter based upon the arrival time of the packets. Therefore, the burst size informational element may play an important part in the configuration of the jitter measurement. Likewise, the configuration of the measurement types may also provide additional information on the jitter measurement. Similar to the other measurements, the jitter measurement may also be configured to operate in autonomous or explicit mode.

TABLE 6
Jitter Measurement Configuration

| Informational | |
|---|---|
| Element | Parameter Description |
| Measurement ID | Jitter |
| Types | A list of the types of measurement values that are |
| | requested. The measurement type can be current value |
| | (e.g. last value or moving average value), minimum, |
| | maximum, average, normalize, etc. |
| Burst size | If measurements are to be sent in a burst, specifies |
| | the number of measurement requests in a burst |
| Schedule | Configuration of a measurement period to obtain the |
| | data transmission measurement autonomously (e.g. |
| | automatic stop and restart of measurement timer) |
| Reporting | Configuration of the reporting period in which DTM |
| | reports are sent |
| Expiration | Configuration in which the data transmission |
| | measurement expires |
| Explicit mode | Specifies the mode of explicit measurement signaling: |
| | start measurement, continue measurement, report and |
| | continue measurement, report and reset measurement, |
| | report and stop measurement. |
| Payload size | If using explicit measurement signaling, specifies |
| | the size in bytes of the payload |

The packet lost rate measurement may be measured by the recipient of the SEALDD traffic and may be used to indicate the rate of packet loss over a known total number of packets. For this measurement, the configuration of the total number of packets may be important since the packet loss rate may be calculated as the ratio of received packets over the total number of packets. The sender may provide the total packets at the beginning of each measurement period and the recipient may record the number of received packets during the period and calculates the packet loss rate percentage using the total transmitted packets. Similar to the other measurements, the packet loss rate measurement may be configured to provide different types of measurement values and may also be configured to operate in autonomous or explicit mode of operation.

TABLE 7
Packet Loss Rate Measurement Configuration

| Informational | |
|---|---|
| Element | Parameter Description |
| Measurement ID | Packet loss rate |
| Types | A list of the types of measurement values that are |
| | requested. The measurement type can be current value |
| | (e.g. last value or moving average value), minimum, |
| | maximum, average, normalize, etc. |
| Total packets | Specifies the number of packets to send for the |
| | measurement |
| Schedule | Configuration of a measurement period to obtain the |
| | data transmission measurement autonomously (e.g. |
| | automatic stop and restart of measurement timer) |
| Reporting | Configuration of the reporting period in which DTM |
| | reports are sent |
| Expiration | Configuration in which the data transmission |
| | measurement expires |
| Explicit mode | Specifies the mode of explicit measurement signaling: |
| | start measurement, continue measurement, report and |
| | continue measurement, report and reset measurement, |
| | report and stop measurement. |
| Payload size | If using explicit measurement signaling, specifies |
| | the size in bytes of the payload |

The retransmission rate may be measured by the sender of the SEALDD traffic and may be used to indicate the rate of retransmissions over a total number of packets or over a measurement period. The sender may decide to retransmit a packet if an acknowledgement is not received within a certain time or a packet may be requested by the recipient. The retransmission rate may be then calculated as the number of retransmitted packets over the total number of packets. Similar to the other measurements, the retransmission rate measurement may be configured to provide different types of measurement values and may also be configured to operate in autonomous or explicit mode of operation.

TABLE 8
Retransmission Rate Measurement Configuration

| Informational | |
|---|---|
| Element | Parameter Description |
| Measurement ID | Retransmission rate |
| Types | A list of the types of measurement values that are |
| | requested. The measurement type can be current value |
| | (e.g. last value or moving average value), minimum, |
| | maximum, average, normalize, etc. |
| Total packets | Specifies the number of packets to send for the |
| | measurement |
| Schedule | Configuration of a measurement period to obtain the |
| | data transmission measurement autonomously (e.g. |
| | automatic stop and restart of measurement timer) |
| Reporting | Configuration of the reporting period in which DTM |
| | reports are sent |
| Expiration | Configuration in which the data transmission |
| | measurement expires |
| Explicit mode | Specifies the mode of explicit measurement signaling: |
| | start measurement, continue measurement, report and |
| | continue measurement, report and reset measurement, |
| | report and stop measurement. |
| Payload size | If using explicit measurement signaling, specifies |
| | the size in bytes of the payload |

SEALDD action guarantee for data delivery service is described herein. A VAL client may use the SEALDD data transmission measurements to assist in making the determination of which VAL servers to send application data to. After VAL server selection and during SEALDD data delivery service, there may disturbances or congestions in the network that degrades the performance of the data delivery service such that it drastically impacts the user experience. In response, the SEALDD layer may be able to provide an “action guarantee” to address such network congestion, disturbances, and/or errors.

An “action guarantee” may signify the ability of the SEALDD layer to perform additional actions to improve the data delivery service without the intervention of VAL applications. Some examples of actions that the SEALDD layer may perform include the request to modify user plane resources in the network for the SEALDD connection, the addition of redundant transport for a particular application traffic, the use of SEALDD data storage or caching capability, the use of SEALDD server forwarding proxy, and even the triggering of autonomous action guarantee by SEALDD servers. Table 9 shows an example of an action guarantee configuration that a SEALDD client, a VAL client, or a VAL server may request from a SEALDD server. The action guarantee configuration may be provided as part of SEALDD connection establishment or DTM measurement enablement requests. Alternatively, the action guarantee configuration may be made separately as an update to a SEALDD connection. In one embodiment, a VAL client may provide information for an action guarantee configuration to a SEALDD client as part of SEALDD data delivery request and in another embodiment, a VAL server may provide an action guarantee configuration to a SEALDD server after reception of application traffic from the SEALDD server. In a third embodiment, a SEALDD client or server may specify action guarantees in response to the enablement of data transmission measurements. The action guarantee configuration may also be based on local or pre-provisioned policies.

TABLE 9
Action Guarantee Configuration Information

| Informational Element | Parameter Description |
|---|---|
| Connection identifier | Specifies a SEALDD connection identifier for the action guarantee |
| DTM configuration | A list of DTM identifiers for which data transmission measurements |
| identifiers | may be monitored for the action guarantee |
| Application identifiers | Specifies the application IDs that may be associated with the action |
| | guarantee |
| Application types | Specifies the application types that may be associated with the action |
| | guarantee |
| Explicit mode | |
| >Action guarantee | An action guarantee requested to be performed by the SEALDD |
| | server. Actions that may be performed includes but not limited to: |
| | modify user plane resources for SEALDD connection, add use of |
| | redundant transports for application traffic, use SEALDD data storage |
| | or caching capability, use SEALDD server forwarding proxy, etc. |
| Autonomous mode | |
| >Enable indicator | This indicator informs the SEALDD server to autonomously perform |
| | the action guarantee based on the specified events |
| >Events | A list of event(s) or rule(s) that may trigger the SEALDD server to |
| | perform action guarantee procedures due to network congestion or |
| | disturbances. |
| >Action guarantees | A list of action guarantees the SEALDD server should perform due to |
| | the trigger of one of the specified events or rules. The list of action |
| | guarantee may be prioritized. For example, when a triggering event is |
| | detected, the first action guarantee in the prioritized list may be |
| | performed. If the desired performance still cannot be achieved, the |
| | next action guarantee in the list may be performed. In autonomous |
| | mode, a potential action guarantee may be the SEALDD server may |
| | determine the action guarantee to perform based on data transmission |
| | measurements. |
| SEALDD data storage or | |
| caching | |
| >Enable indicator | This indicator enables the SEALDD data storage/caching |
| | functionality. |
| >Mode | The function of the SEALDD server: to store/cache data or to retrieve |
| | data. |
| >Contact information | The IP address and port number or MAC address of a SEALDD |
| | server. An identifier associated with the SEALDD server may also be |
| | included. |
| >Storage URI | The storage URI specifies where data is stored or cached in the |
| | SEALDD server. |
| >Retrieval URI | The retrieval URI specifies where data can be retrieved from the |
| | SEALDD server. |
| >Max storage size | A maximum value in bytes to allocate for the temporary storage. |
| >Data expiration | An expiration time when the data will be deleted from the temporary |
| | storage. |
| SEALDD proxy | |
| >Enable indicator | This indicator enables the SEALDD forwarding proxy functionality. |
| >Mode | The proxy can function as incoming mode (receive application data |
| | from another SEALDD server) or outgoing mode (send application |
| | data to another SEALDD server). |
| >Contact information | The IP address and port number or MAC address of a SEALDD server |
| | that the proxy forwards SEALDD flow packets to (for outgoing mode) |
| | or receives SEALDD flow packets from (for incoming mode). An |
| | identifier associated with the SEALDD server may also be included. |

An action guarantee configuration may consist of a SEALDD connection identifier for which the action guarantee applies to, DTM configuration identifiers to specify data transmission measurements that applies for the action guarantee, and/or application identifiers associated with the action guarantee. A SEALDD client may trigger an action guarantee explicitly or allow a SEALDD server to trigger the action guarantee autonomously based on certain events. In explicit mode, the SEALDD client may specify the action guarantee to be performed by the SEALDD server. In autonomous mode, the SEALDD client may provide events or rules that may trigger the action guarantee. The events or rules may specify the limits of data transmission measurements that may trigger the action guarantee. For example, a rule may be to trigger the use of redundant transport if the throughput drops below 90% of a certain throughput level, e.g. 5 Mbps. Another example may be to use SEALDD server forwarding proxy if a connection is not available or is experiencing severe degradation. A third example may be to modify user plane resources for a SEALDD connection if measurements obtained from the 5G network indicate network congestion at a particular UPF that is serving the SEALDD connection. Other examples may also be envisioned for events that trigger action guarantee.

Configurations are also available for the use of SEALDD data storage or caching capability or SEALDD server forwarding proxy. The use of SEALDD data storage or caching capability may be triggered to provide an alternative path for SEALDD data delivery traffic to a SEALDD server that may be able to temporarily store application data. Note that the SEALDD capability of data storage and caching may be referred collectively as temporary data storage hereinafter even though the features may be functionally different. The application traffic may then be requested by the original SEALDD server to forward to the VAL server. Similarly, the use of a SEALDD server forwarding proxy may allow for rerouting SEALDD data delivery traffic through the proxy to the original SEALDD server before forwarding the application traffic to the VAL server. In both cases, the action guarantee provides an alternate route for the SEALDD data delivery traffic.

In addition to using application layer proxies for store and forwarding functionality, the SEALDD server may be enabled to leverage Core Network functionality such as device triggering or changing (if authorized) Core Network downlink buffering and latency parameters. The SEALDD server may also be enabled to autonomously decide to choose alternate delivery mechanism, e.g. SMS, to leverage Core Network store and forward functionality.

Note that some of the aforementioned actions may require the SEALDD client (and hence the UE) to be authorized for certain data delivery service. For example, the use of redundant transports may require additional authorization for the UE. The use of SEALDD data storage or caching may also require authorization. In the following procedures, it may be assumed the SEALDD client is authorized for the depicted action guarantee.

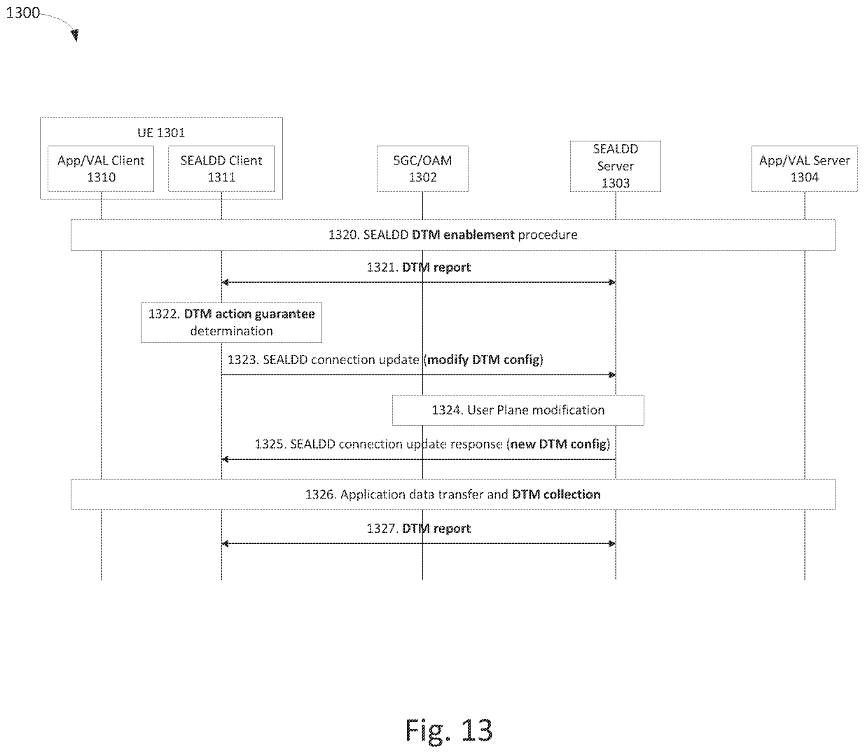

FIG. 13 shows an example procedure 1300 for requesting modification of certain user plane resources for the PDU session carrying the data delivery service. In this example, a SEALDD client 1311, of the UE 1301, requests a SEALDD server 1303 to modify certain user plane resources for the PDU session carrying the data delivery service. The SEALDD client 1311 had established SEALDD data delivery service and enabled SEALDD data transmission measurement collection. After some time, the SEALDD client 1311 may receive an DTM report from the SEALDD server 1303 and the DTM report may indicate that the application traffic is experiencing longer than usual delays or are transferred with a low data rate. In response, the SEALDD client 1311 may request the SEALDD server 1303 to perform an action guarantee, such as requesting user plane modification for the PDU session carrying the data delivery service.

At step 1320, the SEALDD client 1311 and SEALDD server 1303 may negotiate or configure to use Data Transmission Measurements for data delivery service between the VAL client 1310, of the UE 1301, and the VAL server 1304. This step may execute the SEALDD Data Transmission Measurement Enablement procedure as described in FIG. 10.

At step 1321, at the configured reporting interval, a DTM report may be generated and communicated between the SEALDD client 1311 and the SEALDD server 1303. The report may indicate there is network congestion or errors that are causing the data delivery service to not provide the appropriate service guarantee that the VAL application 1304 requires. This step may repeat over multiple reporting periods to provide the SEALDD client 1311 and SEALDD server 1303 with a historical sampling of the data transmission quality over the lifetime of the data delivery service for the VAL application. The DTM report may contain information as listed in Table 2. The SEALDD client 1311 and SEALDD server 1303 may send individual reports for the measurements each has collected for reporting.

At step 1322, the SEALDD client 1311 may determine that the end-to-end data transmission measurement(s) indicate it is not able to meet the data delivery requirement for the application traffic, e.g. due to network congestion. As a result, the SEALDD client 1311 may decide to perform an action guarantee so the data delivery service may be improved to meet the application traffic requirement.

At step 1323, the SEALDD client 1311 may decide to request the SEALDD server 1303 perform user plane management to improve the data delivery service. The SEALDD client 1311 may send a SEALDD connection update request to the SEALDD server 1303 and may include the SEALDD connection identifier, modified DTM configuration information, and the action guarantee configuration as shown in Table 9. The request may also include other information as shown in Table 1 to update the DTM configuration for the SEALDD data delivery connection.

At step 1324, the SEALDD server 1303 may perform the action guarantee as requested in which user plane modifications are made in the 5G network. The SEALDD server 1303 may request from the 5GC 1302 to perform UPF (re) selection or update user plane latency requirement. Other user plane modification examples may be the usage of an Uplink Classifier UPF or a Branching Point UPF and the usage of a Local Area Data Network (LADN) if the UE is within a certain LADN service area. The SEALDD server 1303 may also communicate to an OAM management node 1302 in the network to request user plane modification associated with the PDU session of the data delivery service. This step may be associated with the Application Function (AF) influence on traffic routing procedure where the SEALDD server 1303 acts as an AF. The SEALDD server 1303 may also send measurement subscriptions to the 5GC and other network functions as described in step 1027 of FIG. 10.

At step 1325, the SEALDD server 1303 may respond to the SEALDD client 1311 with the status of the user plane modification request and any DTM configuration information that was changed or updated. The SEALDD server 1303 may also provide updates to the DTM configuration for the SEALDD client 1311.

At step 1326, application data traffic may be sent within the SEALDD data delivery connection and both the SEALDD client 1311 and the SEALDD server 1303 may collect and process data for the data transmission measurements. As a result of user plane modification, the SEALDD connection may be using different underlying user plane resources than what was originally utilized for the application traffic prior to step 5.

At step 1327, at the configured measurement reporting intervals, the SEALDD client 1311 and SEALDD server 1303 may submit DTM reports containing the data transmission measurements that have been enabled and other information as shown in Table 2. The DTM reports may be compared with the DTM report obtained in step 2 to evaluate if the user plane modification was successful in improving the data delivery service. The SEALDD client 1311 and SEALDD server 1303 may send individual reports for the measurements each has collected for reporting.

Another action guarantee that may be requested by a SEALDD client 1311 or performed by a SEALDD server 1303 is the use of redundant transport. SEALDD redundant transport allows application traffic to be routed using two different user plane paths to ensure reliable data delivery of the application traffic from a VAL client to a VAL server. The use of redundant transports may be used to address lower throughputs due to network congestions, increased RTT delays and/or jitter, and higher packet loss or retransmission rates.

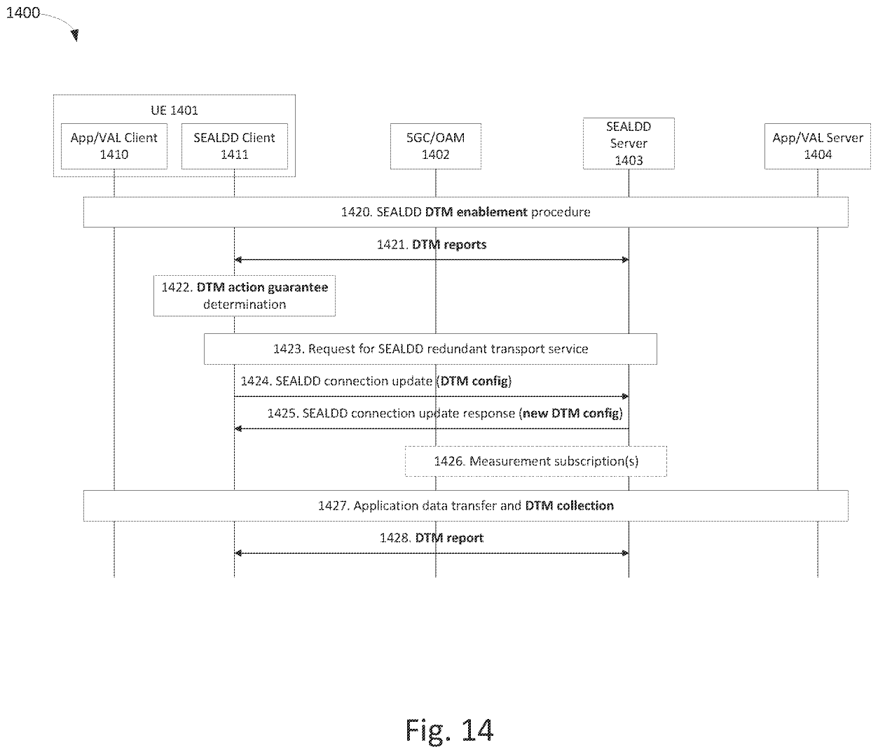

FIG. 14 shows an example procedure 1400 for requesting the use of redundant transport due to a DTM report showing network congestion for a SEALDD connection. In this example, a SEALDD client 1411, of the UE 1401, requests the use of redundant transport due to a DTM report showing network congestion for a SEALDD connection.

Steps 1420-1422 may be the same as steps 1320-1322 from FIG. 13.

At step 1423, the SEALDD client 1411 may decide to utilize redundant transport to improve the data delivery service and may request to use redundant transport for the SEALDD connection. If authorized to use redundant transport, the SEALDD server 1403 may perform AF influence URSP procedure with the 5G network and the UE may need to establish redundant PDU sessions with the 5G network. If the UE is not authorized to use redundant transport, the SEALDD client 1411 may establish a second PDU session and process future application data traffic as if redundant transports were used. In this scenario, the SEALDD layer may be manually managing the redundant transport. Alternatively, the UE may request for authorization to use redundant transport from either the SEALDD server 1403 or from the 5G network.

At step 1424, the SEALDD client 1411 may send a SEALDD connection update request to the SEALDD server 1403 with information about the redundant PDU session, e.g. the UE IP address and port number of the redundant PDU session, or information to manually manage the redundant transport at the SEALDD layer. The request may also include the SEALDD connection identifier and DTM configuration information for the new transport. The request may indicate the action guarantee to be taken due to the previously received DTM report showing there may be network congestion and/or errors experienced by the data delivery service. The action guarantee configuration may be as shown in Table 9. The request may also include other information as shown in Table 1 to update the DTM configuration for the original transport. For example, the SEALDD client 1411 may configure different measurement and reporting intervals.

At step 1425, the SEALDD server 1403 may respond to the SEALDD client 1411 with the status of the SEALDD connection update request and any DTM configuration information that was changed or updated for the original transport. The SEALDD server 1403 may also include DTM configuration for the SEALDD client 1411 to collect and report requested data transmission measurements for the new transport.

At step 1426, the SEALDD server 1403 may subscribe to receive notifications to obtain network measurements and/or analytics for the redundant or new PDU session. The SEALDD server 1403 may also send measurement subscriptions to the 5GC 1402 and other network functions as described in step 7 of FIG. 10.

At step 1427, the SEALDD client 1411 and SEALDD server 1403 manages the redundant application traffic and discards any duplication before sending the data to the VAL layer. In the case that the SEALDD layer is manually managing the redundant transports, additional mapping information may be maintained by both the SEALDD client 1411 and the SEALDD server 1403. At the same time, both the SEALDD client 1411 and the SEALDD server 1403 may collect and process data for the configured data transmission measurements.

At step 1428, at the configured measurement reporting intervals, the SEALDD client 1411 and SEALDD server 1403 may submit DTM reports containing the data transmission measurements that have been enabled and other information as shown in Table 2. The DTM reports may be compared with the DTM report obtained in step 1421 to evaluate if the redundant transport was successful in improving the data delivery service.

The SEALDD layer provides certain capabilities to enhance data delivery services and one such capability is the ability to use a SEALDD server 1403 for data storage or caching. Note that as previously stated, the SEALDD capability of data storage and caching may be referred collectively as temporary data storage even though the features may be different. The SEALDD temporary data storage can be used as an action guarantee where application data may be rerouted to a SEALDD server 1403 with temporary data storage capability. The original SEALDD server 1403 responsible for the application traffic may then retrieve the application data from the SEALDD server 1403 with temporary data storage capability to forward to the VAL server 1404. This action guarantee may be used when the SEALDD connection with the original SEALDD server 1403 is unavailable or experiencing severe degradation.

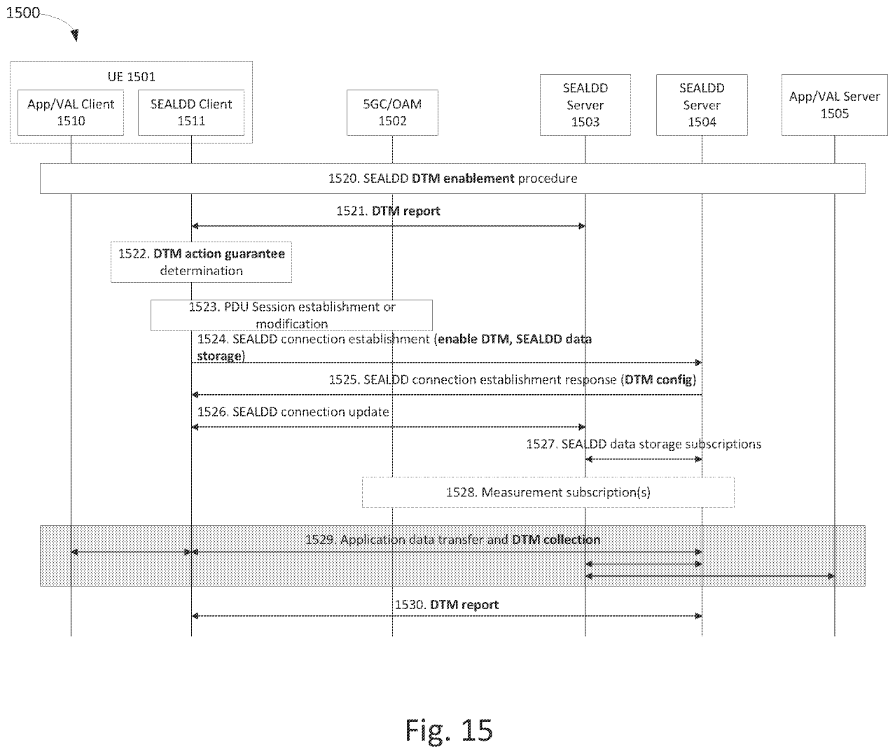

FIG. 15 shows an example procedure 1500 for requesting an alternative path for the application data. In this example, a SEALDD client 1511, of the UE 1501, requests the use of a SEALDD server 1503, 1504 with temporary data storage capability to provide an alternative path for the application data to a VAL server 1505.

Steps 1520-1522 may be performed similar to steps 1320-1322 from FIG. 13.

At step 1523, the SEALDD client 1511 may decide to use the capability of the temporary data storage feature of the SEALDD layer and may establish or modify a PDU session for establishing a SEALDD connection to SEALDD server 1504, which supports the temporary data storage capability. The SEALDD client 1511 may have been provisioned with SEALDD servers that support temporary data storage in step 1021 of FIG. 10 as part of the DTM enablement procedure.

At step 1524, the SEALDD client 1511 may establish a new SEALDD connection with SEALDD server 1504 and may provide the SEALDD connection identifier and DTM configuration information as shown in Table 1 to enable the collection and processing of data transmission measurements. SEALDD client 1511 may also provide action guarantee configuration as shown in Table 9 such as a temporary data storage URI for SEALDD server 1504 to retrieve application data from SEALDD server 1503. The SEALDD client 1511 may have received the URI from SEALDD server 1503 during the original SEALDD connection establishment.

At step 1525, the SEALDD server 1504 may respond to the SEALDD client 1511 with the status of the SEALDD connection request, a resource location identifier such as a URI of where to access the temporary data storage from SEALDD server 1504, and any DTM configuration information that was changed or updated by SEALDD server 1504. SEALDD server 1504 may also include DTM configuration for the SEALDD client 1511 to collect and report requested data transmission measurements for the new SEALDD connection.

At step 1526, the SEALDD client 1511 may perform a SEALDD connection update with SEALDD server 1503 and may provide an action guarantee configuration for configuring SEALDD server 1503 to operate as a data retrieval server. The request may also include the SEALDD connection identifier, the URI provided by SEALDD server 1504 in step 6, and other action guarantee configuration. The URI may allow SEALDD server 1503 to retrieve application data stored at SEALDD server 1504.

At step 1527, the SEALDD server 1503 may subscribe to receive notifications for application data from SEALDD server 1504 using the URI received in step 7. Likewise, SEALDD server 1504 may subscribe to receive notifications for application data from SEALDD server 1503 using the URI received in step 5.

At step 1528, the SEALDD server 1503 and SEALDD server 1504 may subscribe to receive notifications for network measurements and/or analytics from the 5G network and/or from an OAM management node 1502 as described in step 1027 of FIG. 10.

At step 1529, the Application data traffic may be sent within the SEALDD data delivery connection and both the SEALDD client 1511 and SEALDD server 1504 may collect and process data for the data transmission measurements. For the case of uplink application data, the VAL client 1510, of the UE 1501, provides the SEALDD client 1511 with application data and the SEALDD client 1511 transports the data to SEALDD server 1504 over the SEALDD connection. SEALDD server 1504 then notifies SEALDD server 1503 of the application data and SEALDD server 1503 sends the application data to the VAL server 1505. For the case of downlink application data, the VAL server 1505 provides SEALDD server 1503 with application data and SEALDD server 1503 notifies SEALDD server 1504 of the application data. SEALDD server 1504 then transports the application data over the SEALDD connection to the SEALDD client 1511 and the SEALDD client 1511 provides the data to the VAL client.

At step 1530, at the configured measurement reporting intervals, the SEALDD client 1511 and SEALDD server 1504 may submit DTM reports containing the data transmission measurements that have been enabled and other information as shown in Table 2. The DTM reports may be compared with the DTM report obtained in step 2 to evaluate if the SEALDD temporary data storage was successful in improving the data delivery service.

Similar to the action guarantee of using a SEALDD server with temporary data storage capability, a SEALDD client 1511 may also request the use of a SEALDD server that supports forwarding proxy functionality. In this scenario, the SEALDD server forwarding proxy receives application data from the SEALDD client 1511 and forwards the SEALDD traffic to the original SEALDD server, which then forwards the application data to the VAL server.

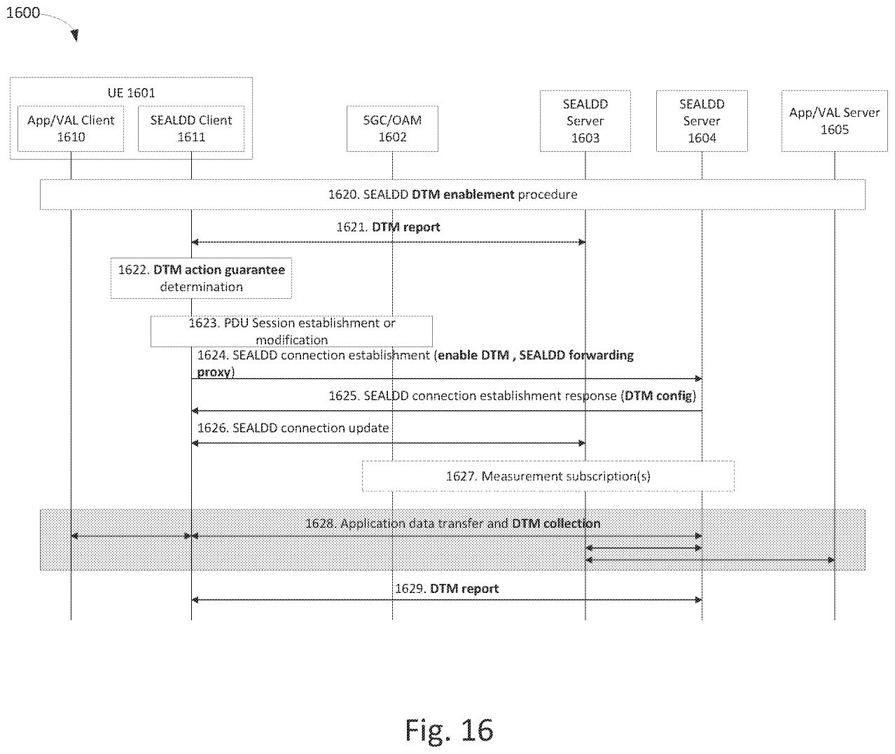

FIG. 16 shows an example procedure 1600 of an action guarantee involving a SEALDD forwarding proxy server. Steps 1620-1622 may be performed similar to steps 1320-1322 from FIG. 13.

At step 1623, the SEALDD client 1611 may decide to establish a new SEALDD connection to a SEALDD proxy to forward SEALDD traffic to SEALDD server 1603 and may establish or modify a PDU session for establishing a SEALDD connection to SEALDD server 1604. The SEALDD client 1611, of the UE 1601, may have been provisioned with SEALDD servers that support SEALDD proxy capability in step 1021 of FIG. 10 as part of the DTM enablement procedure.

At step 1624, the SEALDD client 1611 may establish a new SEALDD connection with SEALDD server 1604 and may provide action guarantee configuration as shown in Table 9 and DTM configuration information as shown in Table 1 to enable the collection and processing of data transmission measurements. SEALDD client 1611 may provide the SEALDD connection identifier, the contact information of SEALDD server 1603, and enabled the forwarding proxy functionality. This configuration may inform SEALDD server 1604 to forward all SEALDD traffic associated with the SEALDD connection identifier to SEALDD server 1603.

At step 1625, the SEALDD server 1604 may respond to the SEALDD client 1611 with the status of the SEALDD connection request and any DTM configuration information that was changed or updated by SEALDD server 1604. SEALDD server 1604 may also include DTM configuration for the SEALDD client 1611 to collect and report requested data transmission measurements for the new SEALDD connection.

At step 1626, the SEALDD client 1611 performs a SEALDD connection update with SEALDD server 1603 and may configure the SEALDD proxy mode to incoming and provide the contact information of SEALDD server 1604. This configuration may inform SEALDD server 1603 to receive all SEALDD traffic associated with the SEALDD flow from SEALDD server 1604 and forward the application data to the VAL server 1605.

At step 1627, the SEALDD server 1603 and SEALDD server 1604 may subscribe to receive notifications for network measurements and/or analytics from the 5G network and/or from an OAM management node 1602 as described in step 1027 of FIG. 10.

At step 1628, the application data may be provided by the VAL client 1610, of the UE 1601, to the SEALDD client 1611. The SEALDD client 1611 transports the application data to SEALDD server 1604 and due to the configuration of SEALDD server 1604 being a forwarding proxy, SEALDD server 1604 may forward the application data to SEALDD server 1603. SEALDD server 1603 may then route the application data to the VAL server 1605. Conversely, application data from the VAL server 1605 is sent to SEALDD server 1603, which forwards the data to SEALDD server 1604. The data is then sent to the SEALDD client 1611, which forwards the data to the VAL client 1610. If configured, both the SEALDD client 1611 and SEALDD server 1604 may collect and process data for the data transmission measurements.

At step 1629, at the configured measurement reporting intervals, the SEALDD client 1611 and SEALDD server 1604 may submit DTM reports containing the data transmission measurements that have been enabled and other information as shown in Table 2. The DTM reports may be compared with the DTM report obtained in step 1621 to evaluate if the SEALDD forwarding proxy was successful in improving the data delivery service.

The aforementioned action guarantee procedures have all been initiated by a SEALDD client 1611 due to DTM reports showing network congestion or disturbances affecting the SEALDD data delivery service. It may be possible for the SEALDD client 1611 to proactively configure a SEALDD server to perform such action guarantees upon measuring or receiving measurements or information about network congestion or disturbances. A SEALDD server may not only be able to collect and measure end-to-end data transmission measurements but it may also be able to receive network performance measurements from the 5G network or obtain analytics statistics or predictions from an analytics function. Due to that capability, a SEALDD server may then be able to perform a configured action guarantee or even be able to autonomously determine the best action guarantee to perform for improving the SEALDD connection quality.

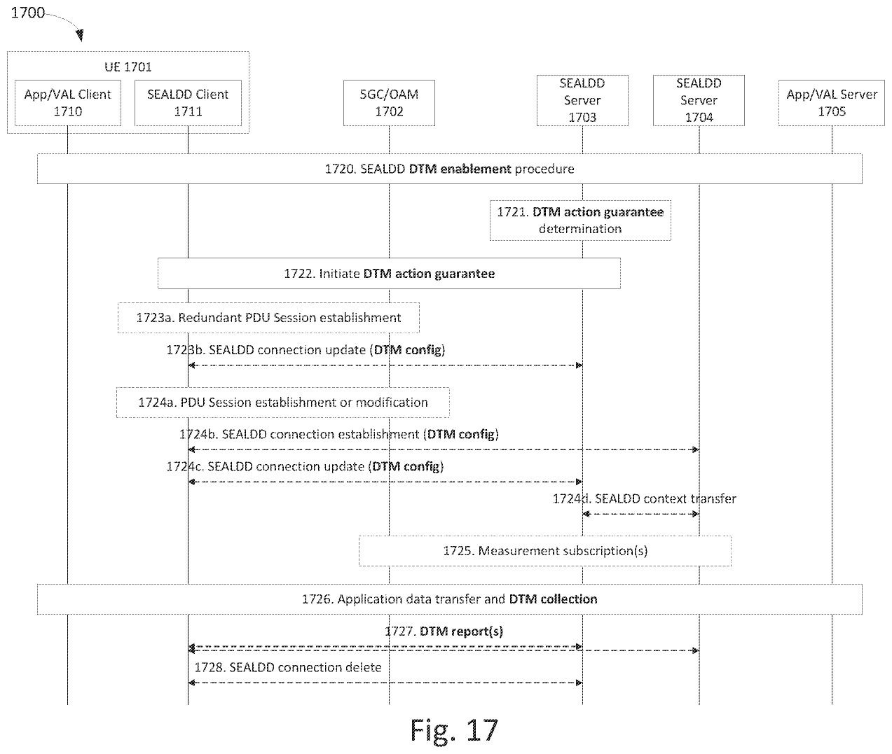

FIG. 17 shows an example procedure 1700 where a SEALDD server is configured to perform autonomous action guarantee. An action guarantee may be triggered due to network congestion and SEALDD server 1703 may be configured with either the action guarantee to be performed or to autonomously determine which action guarantee to perform.

At step 1720, the SEALDD client and SEALDD server 1703 may negotiate or configure to use Data Transmission Measurements for data delivery service between the VAL client 1710, of the UE 1701, and the VAL server 1705. This step may execute the SEALDD Data Transmission Measurement Enablement procedure as described in FIG. 10. In addition, the SEALDD client 1711, of the UE 1701, may also configure SEALDD server 1703 to autonomously perform action guarantee procedures based on one or more events that may indicate network congestion. Alternatively, SEALDD server 1703 may be configured by a local or pre-provisioned policy to perform action guarantee autonomously. The policy may contain rules which trigger autonomous action guarantee.

At step 1721, the SEALDD server 1703 evaluates the data transmission measurements it has obtained against the rules configured for autonomous mode. When a measurement triggers a rule that indicates network congestion or some other network errors may be occurring, SEALDD server 1703 may determine that an action guarantee needs to be performed. Alternatively, SEALDD server 1703 may also determine an action guarantee is required in response to network performance measurements received from the 5G network or statistics or predictions provided by an analytics function indicating possible network congestion that may impact the SEALDD connection.

At step 1722, if an explicit action guarantee is specified, SEALDD server 1703 may perform the configured action guarantee. If the action guarantee is specified to be determined autonomously by the SEALDD server, SEALDD server 1703 may evaluate the data transmission measurements to determine which action guarantee to perform. SEALDD server 1703 may also utilize other measurements and/or analytics obtained from the 5G network in making the action guarantee decision. In addition, SEALDD server 1703 may also utilize application-level analytics that may be available at the SEAL or other application enabler layers. SEALDD server 1703 may initiate action guarantee with the 5G network, the SEALDD client 1711, or another SEALDD server. For example, SEALDD server 1703 may modify user plane resources of the PDU session carrying the data delivery service. Other actions may include SEALDD server 1703 informing the SEALDD client 1711 to use redundant transports, SEALDD server 1703 may utilize the SEALDD temporary data storage feature, or SEALDD server 1703 may re-route application data traffic through a SEALDD forwarding proxy server.

At step 1723a, if the action guarantee is to use redundant transports, the SEALDD client 1711 may establish redundant PDU sessions with the 5G network in step and perform a SEALDD connection update in step 1723b as previously described.

At step 1724a, if the action guarantee is to use another SEALDD connection, a new PDU session may be established or an existing PDU session may be modified. Then the SEALDD client 1711 may perform a SEALDD connection establishment in step 1724b with a SEALDD server. SEALDD server 1703 may have provisioned the SEALDD client 1711 in step 1722 with the identifier and IP address and port number of a SEALDD server to establish the SEALDD connection with. A SEALDD connection update may need to be performed in step 1724c to inform SEALDD server 1703 of the temporary data storage URI or the SEALDD server forwarding proxy address. In step 1724d, SEALDD context information transfer may occur between SEALDD server 1703 and SEALDD server 1704.

At step 1725, if a new SEALDD connection was established or an existing SEALDD connection was modified, then SEALDD server 1703 and SEALDD server 1704 may subscribe to receive notifications for network measurements and/or analytics from the 5G network and/or from an OAM management node 1702 as described in step 7 of FIG. 10.

At step 1726, application data provided by the VAL layer is transported within the SEALDD connection(s) and data transmission measurements are collected and processed by both the SEALDD client 1711 and the SEALDD server as configured.

At step 1727, at the configured measurement reporting intervals, the SEALDD server and/or SEALDD client 1711 may submit DTM reports containing the data transmission measurements that have been enabled and other information as shown in Table 2. There may be one or more DTM reports exchanged depending on the number of SEALDD connections.

At step 1728, if the action guarantee was to use another SEALDD connection, the SEALDD client 1711 may delete the original SEALDD connection with SEALDD server 1703. Alternatively, the originally SEALDD connection may be deleted autonomously after a certain time or as requested by the new SEALDD server after the SEALDD context has been transferred.

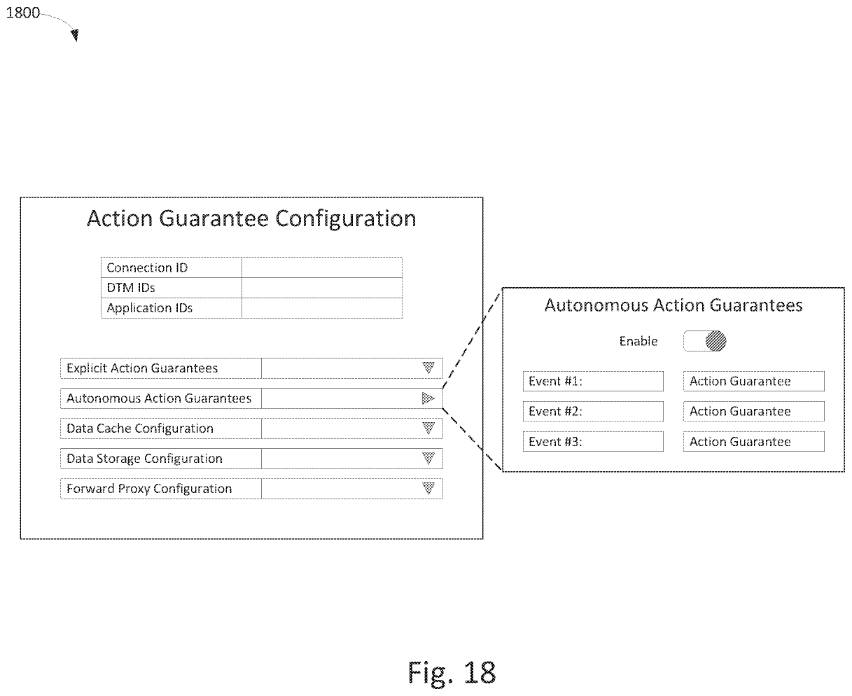

FIG. 18 shows an example graphical user interface (GUI) 1800 in which a user of a UE may provide action guarantee configuration. The GUI may present information captured in Table 9 to present to the user for configuring the action guarantee. The main GUI may show various identifiers for the action guarantee configuration and the different action guarantee configurations that are available to the user. Within each configuration option, another GUI may provide the user with more granular configuration. For example, selecting the Autonomous Action Guarantees configuration may present the user with the ability to configure different events that may trigger a particular action guarantee. The user may also be able to enable or disable the autonomous action guarantees as necessary. For action guarantees that may require other SEALDD capabilities, there may be additional configuration options in the main GUI the user may have access to.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

What is claimed:

1. An apparatus comprising a processor, a memory, and communication circuitry, the apparatus being connected to a network via its communication circuitry, the apparatus further comprising computer-executable instructions stored in the memory of the apparatus which, when executed by the processor of the apparatus, cause the apparatus to:
receive, by a Service Enabler Architecture Layer for Verticals (SEAL) Data Delivery (SEALDD) client of the apparatus, a request for performing one or more data transmission measurements;
perform, by the SEALDD client, the one or more data transmission measurements;
send, by the SEALDD client and to a SEALDD server, first information indicating the one or more data transmission measurements performed by the SEALDD client; and
receive, from the SEALDD server, second information one or more data transmission measurements performed by the SEALDD server.

2. The apparatus of claim 1, wherein the request is received from the SEALDD server.

3. The apparatus of claim 1, wherein the one or more data transmission measurements comprise at least one of:
an application identifier,
a measurement identifier,
a measurement type,
a schedule for performing the one or more data transmission measurements, or
a reporting schedule.

4. The apparatus of claim 1, wherein the first information indicates at least one of: latency, bitrate, jitter, or packet rate loss.

5. The apparatus of claim 1, wherein the second information indicates at least one of: latency, bitrate, jitter, or packet rate loss.

6. The apparatus of claim 1, wherein the computer-executable instructions, when executed by the processor of the apparatus, further cause the apparatus to:
receive an action guarantee configuration indicating one or more events that trigger one or more actions to perform.

7. The apparatus of claim 6, wherein the computer-executable instructions, when executed by the processor of the apparatus, further cause the apparatus to:
perform, based on the first information or the second information, and based on the action guarantee configuration, an action.

8. The apparatus of claim 7, wherein the action comprises sending a request to use redundant transport for a SEALDD connection.

9. A method comprising:
receiving, by a Service Enabler Architecture Layer for Verticals (SEAL) Data Delivery (SEALDD) client, a request for performing one or more data transmission measurements;
performing, by the SEALDD client, the one or more data transmission measurements;
sending, by the SEALDD client and to a SEALDD server, first information indicating the one or more data transmission measurements performed by the SEALDD client; and
receiving, from the SEALDD server, second information one or more data transmission measurements performed by the SEALDD server.

10. The method of claim 9, wherein the request is received from the SEALDD server.

11. The method of claim 9, wherein the one or more data transmission measurements comprise at least one of:
an application identifier,
a measurement identifier,
a measurement type,
a schedule for performing the one or more data transmission measurements, or
a reporting schedule.

12. The method of claim 9, wherein the first information indicates at least one of: latency, bitrate, jitter, or packet rate loss.

13. The method of claim 9, wherein the second information indicates at least one of: latency, bitrate, jitter, or packet rate loss.

14. The method of claim 9, wherein the computer-executable instructions, when executed by the processor of the apparatus, further cause the apparatus to:
receive an action guarantee configuration indicating one or more events that trigger one or more actions to perform.

15. The method of claim 14, wherein the computer-executable instructions, when executed by the processor of the apparatus, further cause the apparatus to:
perform, based on the first information or the second information, and based on the action guarantee configuration, an action, wherein the action comprises sending a request to use redundant transport for a SEALDD connection.
